(19) United States
(12) Patent Application Publication
(10) Pub. No.: US 2018/0249646 A1
(43) Pub. Date: Sep. 6, 2018

(54) LEAF CLEARING DEVICE

(71) Applicant: Positec Power Tools (Suzhou) Co., Ltd, Suzhou (CN)

(72) Inventors: Shisong Zhang, Suzhou (CN); Fu Qian, Suzhou (CN); Mingjian Xie, Suzhou (CN); Shiping Jiao, Suzhou (CN)

(73) Assignee: Positec Power Tools (Suzhou) Co., Ltd., Suzhou (CN)

(21) Appl. No.: 15/760,150

(22) PCT Filed: Sep. 9, 2016
(86) PCT No.: PCT/CN2016/098589

§ 371 Date: Mar. 14, 2018

(30) Foreign Application Priority Data
Sep. 18, 2015 (CN) 201510600033.4
Nov. 24, 2015 (CN) 201510823222.8
Jun. 20, 2016 (CN) 201610443935.6
Jun. 20, 2016 (CN) 201610444321.X
Jun. 20, 2016 (CN) 201620605749.3
Jun. 20, 2016 (CN) 201620606254.2

(51) Int. Cl. A01G 20/47; A47L 5/22; A47L 7/00

(52) U.S. Cl. CPC A01G 20/47; B02C 18/186; A47L 7/0085; A47L 5/22

(57) ABSTRACT

This disclosure relates to a leaf cleaning device including: a housing; an air inlet configured to suck leaves into the housing; an air outlet configured to discharge leaves from the housing, the air outlet connected to a leaf collection apparatus; a motor located inside the housing; and a leaf pulverizing apparatus driven by the motor and configured to pulverize the leaves, wherein an area of the air inlet is greater than 260 square centimeters.

### CROSS-REFERENCE TO RELATED APPLICATIONS

This application is a national phase entry under 35 U.S.C. § 371 of International Patent Application PCT/CN2016/098589, filed Sep. 9, 2016, designating the United States of America and published as International Patent Publication WO 2017/045569 A1 on Mar. 23, 2017, which claims the benefit under Article 8 of the Patent Cooperation Treaty to Chinese Patent Application Serial Nos. 201510600033.4 filed Sep. 18, 2015, 201510823222.8 filed Nov. 24, 2015, 201610444321.X filed Jun. 20, 2016, 201610443935.6 filed Jun. 20, 2016, 201620606254.2 filed Jun. 20, 2016, and 201620605749.3 filed Jun. 20, 2016.

### TECHNICAL FIELD

This application relates to an electric tool and, in particular, to a leaf cleaning device.

### BACKGROUND

As the urban greening area continuously enlarges, and greenbelts of parks, roads, and public spaces spread all over the country, lawn pruning tools are widely used. A leaf cleaning device is one of the lawn pruning tools, and is mainly used for caring for leaves scattered over a lawn.

The leaf cleaning device has an air inlet and an air outlet and is configured to suck the leaves scattered over the lawn into the inside of the machine by using the air inlet. The leaf cleaning device is internally provided with a high-speed rotating blade that pulverizes the leaves sucked into the inside of the leaf cleaning device. Lead by an air flow, the pulverized leaves are eventually discharged through the air outlet of the leaf cleaning device. In general conditions, a user may connect a leaf collection bag to the air outlet of the leaf cleaning device, thereby collecting the pulverized leaves sucked into the leaf collection bag after being pulverized by the blade of the leaf cleaning device. The user dumps the pulverized leaves out of the leaf collection bag, so that complete leaf removing work is completed.

In the currently used leaf cleaning devices, some leaf cleaning devices are hand-held. When a hand-held leaf cleaning device is in use, a leaf collection bag is generally fitted to the air outlet of the leaf cleaning device. The user needs to carry the leaf collection bag while continuously holding the leaf cleaning device when walking on the lawn to remove the leaves scattered on the lawn. Carrying the leaf collection bag on the back will cause the user to be stained with much dust. More importantly, when a lawn that needs to be cleaned by the user is relatively large and there are more scattered leaves, the user needs to continuously hold the leaf cleaning device for a long time to perform a cleaning operation. Consequently, the user bears a heavy burden and is likely to suffer from fatigue.

The others are hand-push leaf cleaning devices. Such a hand-push leaf cleaning device is generally provided with a pair of wheels and a corresponding pair of handles for the user to hold. The user holds the handles to push the leaf cleaning device to move across the lawn by using the wheels, in order to suck in and pulverize, by using a blade, the leaves scattered on the lawn. The leaves are eventually discharged through the air outlet and are collected by using the leaf collection bag.

The hand-push leaf cleaning device needs the user to continuously hold the handles while continually adjusting the arm angle so as to adjust the position of the air inlet of the leaf cleaning device to improve the efficiency of sucking in the leaves on the lawn. Similarly, when a lawn that needs to be cleaned is very large and there are more scattered leaves, the user is required to continuously hold the leaf cleaning device to push the leaf cleaning device to perform a cleaning operation. Consequently, the user bears a heavy burden and is likely to suffer from fatigue.

Moreover, the air inlet of the existing leaf cleaning device is generally disposed close to the ground, and a distance between the air inlet and the ground is smaller, being similar to a structure of a household vacuum cleaner. However, the size of sucking in leaves on the ground by using the air inlet in such a structure is limited, causing lower work efficiency. Therefore, a leaf cleaning device that may be placed on the ground for use and has higher leaf suction efficiency is desired.

In addition, the air inlet of such a hand-push leaf cleaning device is generally in a flat shape, being similar to a suction nozzle of a household vacuum cleaner. Such an air inlet has a smaller opening size and is not beneficial to efficiently sucking in leaves, and the leaves need to pass through a narrow and long channel to be pulverized by a blade. Therefore, the overall leaf removal efficiency is not high, which needs to be improved.

### BRIEF SUMMARY

To overcome defects of the prior art, the technical problem to be resolved by this disclosure is to provide a leaf cleaning device that has higher leaf suction efficiency.

To resolve the foregoing problem, technical solutions of this disclosure are as follows.

A leaf cleaning device, comprising: a housing; an air inlet where leaves enter the inside of the housing through the air inlet; an air outlet where the leaves are discharged from the inside of the housing through the air outlet, the air outlet being used for connecting to a leaf collection apparatus; a motor, where the motor being located inside the housing; and a leaf pulverizing apparatus driven by the motor to rotate about an axis to pulverize the leaves, the area of the air inlet being greater than 260 square centimeters.

In an embodiment, the air inlet is in a shape of a rectangular opening.

In an embodiment, the air inlet has a length-to-width ratio in a range of greater than 0.5 and less than 2.

In an embodiment, the housing comprises a spiral housing and a first extending portion connected to the spiral housing, the first extending portion having a first end connected to a center of the spiral housing and a second end connected to the air inlet. A cross-sectional area of the first end of the first extending portion is smaller than a cross-sectional area of the second end.

In an embodiment, the cross-sectional area of the first end is greater than 95 square centimeters.

In an embodiment, the first extending portion has a gradually increasing cross-sectional area from the first end to the second end.

In an embodiment, the leaf pulverizing apparatus is located at the center of the spiral housing, and the motor and the first extending portion are located on two opposite sides of the leaf pulverizing apparatus.

In an embodiment, a distance between the leaf pulverizing apparatus and the air inlet is less than 30 cm.

In an embodiment, the leaf pulverizing apparatus comprises a rotating disc and a flexible member disposed on the rotating disc, the center of the rotating disc being fitted to an output shaft of the motor.

In an embodiment, the flexible member is a nylon rope.

Compared with the prior art, a size and shape of an air inlet of the leaf cleaning device in this disclosure are beneficial to rapidly sucking in leaves, making the work efficiency higher.

To overcome defects of the prior art, the technical problem to be resolved by this disclosure is to provide a leaf cleaning device that may be placed on the ground for use and has higher leaf suction efficiency.

To resolve the foregoing problem, a technical solution of this disclosure is as follows:

A leaf cleaning device is provided. The leaf cleaning device includes: a housing; an air inlet where leaves enter the inside of the housing therethrough; an air outlet where the leaves are discharged from the inside of the housing therethrough, the air outlet being used for connecting to a leaf collection apparatus; a motor, wherein the motor is located inside the housing; a leaf pulverizing apparatus driven by the motor to rotate about an axis to pulverize the leaves; and the leaf cleaning device includes a support portion supported on the ground, and when the support portion is supported by the ground, the air inlet is close to the ground with an angle of less than 60 degrees existing between the ground and a direction toward which the air inlet faces.

In an embodiment, the direction toward which the air inlet faces is parallel to the ground.

In an embodiment, a direction toward which the air outlet faces is parallel to the ground.

In an embodiment, the housing includes a spiral housing, a first extending portion connected to a center of the spiral housing, and a second extending portion connected to an end of the spiral housing, wherein the first extending portion is connected to the air inlet, and the second extending portion is connected to the air outlet.

In an embodiment, the support portion is disposed on the first extending portion.

In an embodiment, the first extending portion has a first end connected to the spiral housing and a second end connected to the air inlet, wherein the first end is disposed toward the ground.

In an embodiment, the leaf pulverizing apparatus comprises a rotating disc and a flexible member disposed on the rotating disc, and a center of the rotating disc is fitted to an output shaft of the motor.

In an embodiment, the flexible member is a nylon rope.

To resolve the foregoing problem, a technical solution of this disclosure is as follows. A leaf cleaning device includes: a housing; an air inlet, wherein leaves enter the inside of the housing through the air inlet; an air outlet, wherein the leaves are discharged from the inside of the housing through the air outlet, and the air outlet is used for connecting to a leaf collection apparatus; a motor, wherein the motor is located inside the housing; a leaf pulverizing apparatus, driven by the motor to rotate about an axis to pulverize the leaves; and the leaf cleaning device includes a support portion that can be supported on the ground. The air inlet has a normal line running through the air inlet, and when the support portion is supported by the ground, an angle of less than 60 degrees exists between the normal line and the ground.

To resolve the foregoing problem, a technical solution of this disclosure is as follows. A leaf cleaning device includes: a housing; an air inlet, wherein leaves enter the inside of the housing through the air inlet; an air outlet, wherein the leaves are discharged from the inside of the housing through the air outlet, and the air outlet is used for connecting to a leaf collection apparatus; a motor, wherein the motor is located inside the housing; a leaf pulverizing apparatus, driven by the motor to rotate about an axis to pulverize the leaves; and the leaf cleaning device includes a support portion that can be supported on the ground, the support portion defining a support plane, the air inlet defining an air intake plane that allows leaves to pass through, and the angle between the support plane and the air intake plane being greater than 30 degrees.

Compared with the prior art, the leaf cleaning device of this disclosure may be placed on the ground for use, does not need to be continuously and firmly held by a user, is convenient to be operated, is simple and practical, and has higher leaf suction efficiency.

To overcome defects of the prior art, the technical problem to be resolved by this disclosure is to provide a rapid replacement apparatus that implements rapid replacement of a blade of a leaf cleaning device.

To resolve the foregoing problem, a technical solution of this disclosure is as follows. A rapid replacement apparatus is provided. The rapid replacement apparatus is disposed in a leaf cleaning device, and the rapid replacement apparatus is used for mounting a blade. The rapid replacement apparatus includes: a mounting cover, wherein the mounting cover includes a first surface with a slot formed thereon, the slot extending to an edge of the first surface and used for clamping the blade; and a rotating disc, wherein the rotating disc is detachably connected to the mounting cover.

In an embodiment, the mounting cover further includes a second surface, wherein the second surface is opposite to the first surface, a first groove is formed on the second surface, a first through hole and a second through hole are formed on a bottom surface of the first groove, the first through hole and the second through hole are respectively used for one end of the blade to run through, and the blade running through the first through hole and the second through hole is clamped in the slot.

In an embodiment, there are four first grooves and four corresponding slots, and the four first grooves are symmetrically arranged.

In an embodiment, a second groove is formed on the first surface, a third through hole is formed on an inner wall of the second groove, the third through hole is used for the blade to run through, and the blade running through the third through hole is clamped in the slot.

In an embodiment, the mounting cover further includes a protruding portion, and the protruding portion extends outward from an edge of the first surface. A third groove is formed on an outer surface of the rotating disc, the third groove matches the protruding portion.

In an embodiment, a fourth groove is formed on the rotating disc, and a surface that is of the rotating disc and that is provided with the fourth groove is in contact with and is connected to the first surface.

In an embodiment, a limiting plate is disposed on a bottom portion of the fourth groove, the limiting plate being in contact with and connected to an inner wall of the fourth groove, with the limiting plate being clamped in the slot.

In an embodiment, a width of the slot is equal to a width of the limiting plate, and the width of the limiting plate is the width that is in a direction perpendicular to the inner wall of the fourth groove.

To resolve the foregoing problem, a technical solution of the disclosure is as follows. A leaf cleaning device includes: an air intake portion, a motor, a spiral housing, a blade, and the foregoing rapid replacement apparatus, wherein the air intake portion is connected to one side of the spiral housing, the rapid replacement apparatus is disposed in the spiral housing, the motor is connected to the other side of the spiral housing, and an output shaft of the motor is connected to the rotating disc. The motor drives the rotating disc to rotate, and the blade is mounted in the rapid replacement apparatus.

The foregoing leaf cleaning device has an apparatus for rapidly replacing a blade, and can implement rapid replacement of the blade.

To overcome defects of the prior art, the technical problem to be resolved by this disclosure is to provide a leaf cleaning device that has lower costs and is convenient for use.

To resolve the foregoing problem, a technical solution of this disclosure is as follows. A mounting assembly that can respectively connect to a leaf cleaning device and a collection bag is provided. The leaf cleaning device is used for sucking in and pulverizing leaves, and the collection bag is used for collecting the pulverized leaves. The mounting assembly includes an air-permeable portion enabling air to be discharged from the inside of the mounting assembly to the outside through the air-permeable portion. The mounting assembly further includes an inner ring and an outer ring that coordinate with and act on each other, where one of the inner ring and the outer ring is connected to a bag mouth of the collection bag, the other one of the inner ring and the outer ring is connected to the air-permeable portion, and the inner ring and the outer ring circumferentially abut against each other, so as to enable the mounting assembly to connect to the bag mouth of the collection bag.

Preferably, the inner ring is an annular elastic member, and the annular elastic member generates bias pressure to enable a radial outer side of the annular elastic member to coordinate with a radial inner side of the outer ring.

Preferably, a radius of the annular elastic member is equal to a radius of the outer ring.

Preferably, the collection bag is a plastic trash bag.

Preferably, the annular hoop is operatively separated from the collection bag, and an edge of the bag mouth of the collection bag is operatively folded to wrap the outer ring.

Preferably, a thickness of the plastic trash bag is less than 0.1 mm.

Preferably, the air-permeable portion has a first opening and a second opening that are through, where the inner ring is disposed in the first opening, and the second opening is connected to the leaf cleaning device.

Preferably, the first opening has a flange that wraps the inner ring.

Preferably, the second opening is provided with a tightening band that can tighten the second opening.

Preferably, a material of the air-permeable portion is a mesh cloth, and a surface of the mesh cloth is provided with an air hole.

Compared with the prior art, the leaf collection apparatus of this disclosure uses the plastic trash bag, has lower costs, and uses the mounting assembly to overcome disadvantages of the plastic trash bag, so that the leaf collection apparatus is overall simple and practical, and has lower costs.

### BRIEF DESCRIPTION OF THE DRAWINGS

The foregoing objectives, technical solutions, and beneficial effects of this disclosure may be obtained by using the following detailed descriptions of specific embodiments that can achieve the disclosure with reference to descriptions of the accompanying drawings.

The same reference numerals and symbols in the accompanying drawings and the specification are used for representing the same or equivalent elements.

FIG. 1 is an overall schematic diagram of a leaf cleaning device according to a first embodiment of the disclosure;

FIG. 2 is a schematic three-dimensional exploded view of the leaf cleaning device in FIG. 1;

FIG. 3 is a schematic diagram of an internal structure of the leaf cleaning device in FIG. 1;

FIG. 4 is a schematic exploded view of a first embodiment of a leaf pulverizing apparatus of the leaf cleaning device in FIG. 1;

FIG. 5 is a schematic structural diagram of a second embodiment of a leaf pulverizing apparatus of the leaf cleaning device in FIG. 1;

FIG. 6 is a schematic structural diagram of a mounting cover shown in FIG. 5;

FIG. 7 is a schematic structural diagram after a blade is mounted to the mounting cover shown in FIG. 6;

FIG. 8 is a schematic structural diagram of a leaf cleaning device according to an embodiment to which the leaf pulverizing apparatus shown in FIG. 5 is mounted;

FIG. 9 is an overall schematic diagram of a second embodiment of a leaf pulverizing apparatus of the leaf cleaning device in FIG. 1;

FIG. 10 is a schematic cross-sectional view of a blade of the leaf pulverizing apparatus in FIG. 9;

FIG. 11 is a schematic exploded view of a third embodiment of a leaf pulverizing apparatus of the leaf cleaning device in FIG. 1;

FIG. 12 is an overall schematic diagram of a fourth embodiment of a leaf pulverizing apparatus of the leaf cleaning device in FIG. 1;

FIG. 13 is a schematic three-dimensional view of a spiral housing part of the leaf cleaning device in FIG. 1;

FIG. 14 is an overall schematic diagram of a leaf cleaning device according to a second embodiment of the disclosure;

FIG. 15 is an overall schematic diagram of a leaf cleaning device according to a third embodiment of the disclosure;

FIG. 16 is an overall schematic diagram of a leaf cleaning device according to a fourth embodiment of the disclosure;

FIG. 17 is a three-dimensional view of a first embodiment of a leaf collection bag fitted to a leaf cleaning device according to the disclosure;

FIG. 18 is a three-dimensional view of a second embodiment of a leaf collection bag fitted to a leaf cleaning device according to the disclosure;

FIG. 19 is a schematic diagram of an auxiliary mounting member of the leaf collection bag shown in FIG. 18;

FIG. 20 is a schematic diagram of the auxiliary mounting member shown in FIG. 19 when a block portion is mounted to the auxiliary mounting member;

FIG. 21 is schematic three-dimensional view when the leaf cleaning device according to the first embodiment of the disclosure is fitted to the second embodiment of a leaf collection bag;

FIG. 22 is a schematic diagram of a leaf collection bag according to another embodiment of the disclosure connecting to a leaf cleaning device;

FIG. 23 is a schematic exploded view of the leaf collection bag in FIG. 22;

FIG. 24 is a schematic diagram of an unfolded edge of a bag mouth when an annular hoop in FIG. 22 is mounted to the bag mouth;

FIG. 25 is a schematic diagram of a folded edge of a bag mouth when an annular hoop in FIG. 22 is mounted to the bag mouth;

FIG. 26 is a schematic three-dimensional view of the leaf cleaning device according to the first embodiment of the disclosure when a control rod is mounted to the leaf cleaning device;

FIG. 27 is a schematic three-dimensional view of the leaf cleaning device according to the first embodiment of the disclosure when a foot switch is mounted to the leaf cleaning device;

FIG. 28 is a schematic diagram of a non-stepped state of a second embodiment of the foot switch in FIG. 27;

FIG. 29 is a schematic diagram of the foot switch in FIG. 28 in a stepped state;

FIG. 30 is a schematic diagram of the leaf cleaning device according to the first embodiment of the disclosure when a roller is mounted to the leaf cleaning device; and

FIG. 31 is a schematic diagram of the leaf cleaning device according to the first embodiment of the disclosure forming a leaf removal system with a rake.

### DETAILED DESCRIPTION

The following describes preferred embodiments of the disclosure in detail with reference to the accompanying drawings, to enable advantages and features of the disclosure to be more easily understood by a person skilled in the art, so as to more clearly define the protection scope of this disclosure.

Position terms such as “above,” “below,” and “perpendicular” mentioned in the disclosure are with reference to a status of a leaf cleaning device when the leaf cleaning device is placed on the ground to suck in and pulverize leaves. The “above” means being away from the ground, and the “below” means being close to the ground. If not especially stated, descriptions of positions related in the following, such as the “above” and “below,” are consistent with the explanation herein.

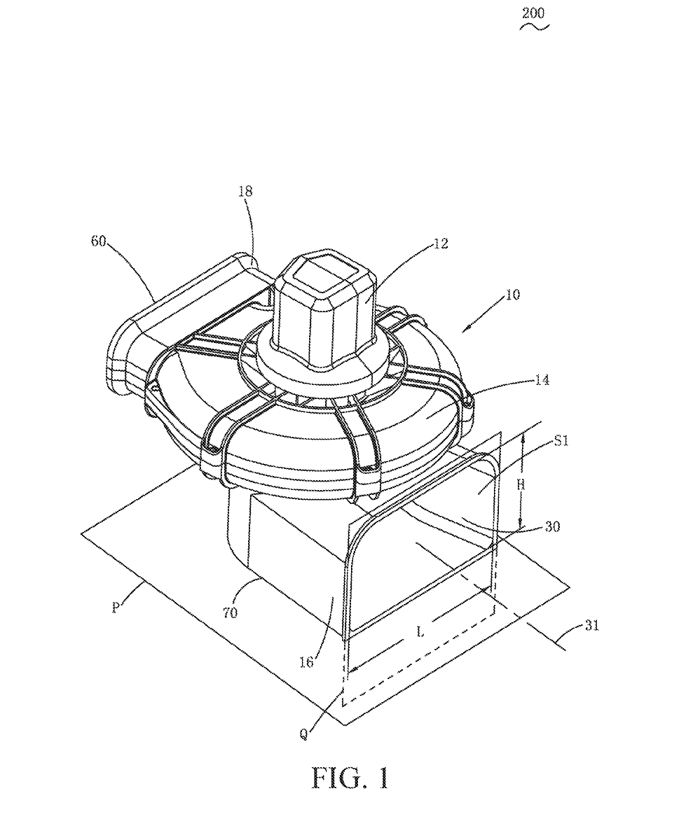

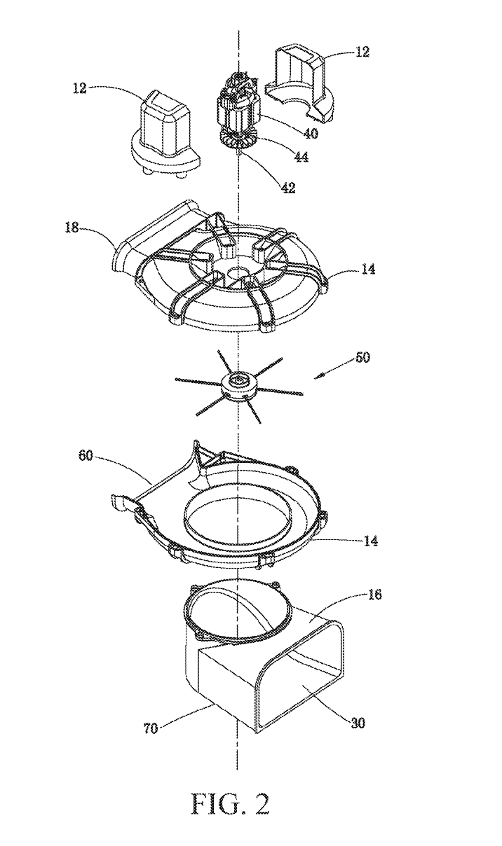

FIGS. 1 through 3 show a leaf cleaning device 200 according to a first embodiment of the disclosure. The leaf cleaning device 200 includes a housing 10, an air inlet 30 disposed on the housing 10, with leaves entering the inside of the housing 10 through the air inlet 30. The inside of the housing 10 is further provided with a motor 40. The leaf cleaning device 200 further includes a leaf pulverizing apparatus 50 that is driven by the motor 40 to rotate about an axis to pulverize the leaves sucked in through the air inlet 30. The leaf cleaning device 200 further includes an air outlet 60 disposed on the housing 10, with an air flow and the leaves pulverized by the leaf pulverizing apparatus 50 being discharged through the air outlet 60. The leaf cleaning device 200 includes a support portion 70 supported on the ground. As shown in FIG. 1, the support portion 70 is located on the housing 10, with the support portion 70 disposed close to the air inlet 30. When the leaf cleaning device 200 is in use, the support portion 70 is stably supported on the ground. A user can easily release the grip they have on the handle with their hands, and does not need to hold the leaf cleaning device 200. When the support portion 70 is supported by the ground in order to efficiently suck in the leaves, the air inlet 30 is close to the ground, and an angle exists between the ground and a direction to which the air inlet 30 faces. The angle is less than 60 degrees. In this way, leaves on the ground are ensured to rapidly enter the air inlet 30, and because the angle exists, leaves of a large size on the ground near the air inlet 30 can be all sucked into the air inlet 30.

The air inlet 30 further has a normal line 31 running through the air inlet 30, with the normal line 31 extending along the direction to which the air inlet 30 faces. Therefore, when the support portion 70 is supported by the ground, an angle of less than 60 degrees exists between the normal line 31 and the ground. Certainly, the support portion 70 defines a support plane P. Basically, as shown in FIG. 1, the support plane P is horizontally placed, and the leaf cleaning device 200 is located on the support plane P. The air inlet 30 defines an air intake plane Q, and the leaves and air pass through the air intake plane Q to enter the inside of the housing 10. It needs to be noted that an angle between the support plane P and the air intake plane Q is greater than 30 degrees. In a preferred embodiment, the maximum angle is 90 degrees and, in this case, the support plane P is perpendicular to the air intake plane Q.

In this preferred embodiment shown in FIG. 1, the angle between the ground and the direction to which the air inlet 30 faces is 0 degrees, that is, the direction to which the air inlet 30 faces is parallel to the ground. The degree between the normal line 31 and the ground is 0 degrees, and the angle between the support plane P and the air intake plane Q is 90 degrees.

The housing 10 includes a motor accommodating housing 12, a spiral housing 14, a first extending portion 16, and a second extending portion 18. The motor accommodating housing 12 consists of two half housings, and after the two half housings are spliced, a hollow portion for accommodating the motor 40 is formed in the middle. The motor 40 is disposed in a vertical direction inside the motor accommodating housing 12, and an output shaft 42 of the motor 40 is perpendicular to the ground. A heat dissipating fan 44 is coaxially disposed on the output shaft 42 of the motor 40, and the heat dissipating fan 44 is used for performing a heat dissipation process on heat generated when the motor 40 rotates.

The spiral housing 14 is internally designed as a circular arc surface. Such a design helps to reduce the windage and form a smooth air flow channel. The spiral housing 14 is already widely applied to the field of electric tools, such as an air blower, and a mower. The specific working principle of the spiral housing 14 is not described in detail herein. The spiral housing 14 may be made of a transparent material. Being made of the transparent material can ensure that when the leaf cleaning device 200 is working, a user can observe an operation status of the leaf pulverizing apparatus 50, so that the user can easily avoid touching the leaf pulverizing apparatus 50, thereby ensuring the operation safety of the user. An opening is formed on a central part of an upper end of the spiral housing 14, and the output shaft 42 of the motor extends into the inside of the spiral housing 14 through the opening of the central part.

The housing 10 of the leaf cleaning device 200 includes the first extending portion 16 and the second extending portion 18. The first extending portion 16 is located between the air inlet 30 and the spiral housing 14, and is used for guiding the air and leaves to enter the spiral housing 14 through the air inlet 30. Similarly, an opening is formed on a central part of a lower end of the spiral housing 14, and one end of the first extending portion 16 is in communication with the spiral housing 14 at the opening of the central part of the lower end of the spiral housing 14, so as to enable a first end of the first extending portion 16 to be connected to a center of the spiral housing 14. The other opposite end of the first extending portion 16, that is, a second end of the first extending portion 16, is connected to the air inlet 30. In a preferred embodiment, a horizontal distance between the first end and the second end of the first extending portion 16 is less than 30 cm. In this way, a shorter passing distance is ensured in a process of the leaves moving from the air inlet 30 to the center of the spiral housing 14, and congestion at the first extending portion 16 will not occur. In a preferred embodiment, the horizontal distance between the first end and the second end is less than 20 cm. One end of the second extending portion 18 is in communication with the spiral housing 14, and the other opposite end is the air outlet 60.

A cross section that is at the opening of the central part of the lower end of the spiral housing 14 and that is in communication with the first extending portion 16 is circular. A person skilled in the art may imagine that a shape of the communication cross section is not limited to a circle, and another communication cross section of any other shape that can implement air circulation falls within the protection scope of this disclosure. In this embodiment, a straight line of the output shaft 42 of the motor 40, a center line of the opening of the upper end of the spiral housing 14, a center line of the opening of the lower end of the spiral housing 14, and a center line of a communication end between the first extending portion 16 and the spiral housing 14 coincide, and are all perpendicular to the ground.

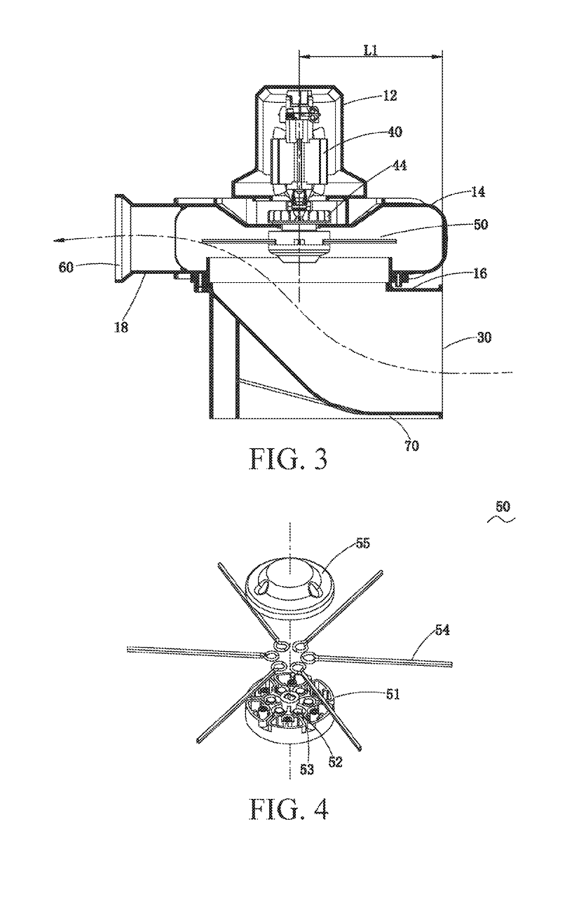

Referring to FIG. 4, inside the spiral housing 14, an end of the output shaft 42 of the motor 40 is provided with the leaf pulverizing apparatus 50. In this embodiment, the leaf pulverizing apparatus 50 includes a rotating disc 51, and the rotating disc 51 is circumferentially provided with a mounting protrusion 52 and a guide groove 53. The leaf pulverizing apparatus 50 includes a blade 54 for pulverizing leaves sucked into the inside of the leaf cleaning device 200. The blade 54 is mounted and fastened onto the rotating disc 51 by means of coordination with the mounting protrusion 52 and other parts of the blade 54 extending outside a body of the rotating disc 51 from the guide groove 53.

The leaf pulverizing apparatus 50 further includes a mounting cover 55 fitted to the rotating disc 51. After the blade 54 is mounted to the rotating disc 51 by using the mounting protrusion 52 and the guide groove 53, the mounting cover 55 is fitted to the rotating disc 51 to eventually firmly fasten the blade 54 onto the rotating disc 51. The rotating disc 51 and the mounting cover 55 may implement rapid assembly and rapid disassembly by using a rapid removal method. A person skilled in the art may imagine that there are multiple rapid removal methods including, but not limited to, using a snap-on method and the like. Central parts of the rotating disc 51 and the mounting cover 55 are both provided with an opening, and the openings may be fitted to the output shaft 42 of the motor 40 to deliver rotation of the motor 40 to the rotating disc 51 so as to eventually drive the blade 54 to pulverize the leaves entering the leaf cleaning device 200.

In a preferred embodiment, the blade 54 is a flexible member. This can reduce potential damage caused to a user. In this embodiment, the blade 54 is a flexible nylon rope, and there are six strands of nylon rope. In another embodiment, the number of the nylon rope may alternatively be another number, not limited to six strands used in this embodiment. The nylon rope is mounted and fastened onto the rotating disc 51 by using the mounting protrusion 52 and other parts of the nylon rope are guided outside the rotating disc 51 by using the guide groove 53. The motor 40 drives the rotating disc 51 to rotate, and the rotating disc 51 rotates to drive the nylon rope to rotate, so as to pulverize the leaves entering the leaf cleaning device 200.

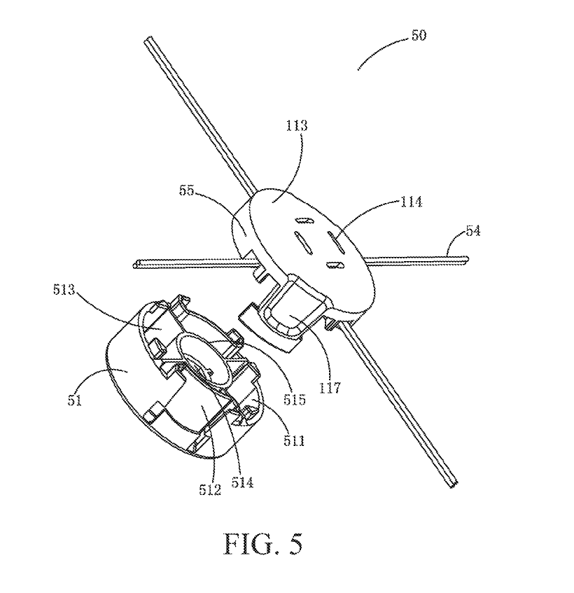

As shown in FIG. 5, a leaf pulverizing apparatus 50 according to another embodiment of the disclosure includes a mounting cover 55 and a rotating disc 51. The leaf pulverizing apparatus 50 is disposed in the leaf cleaning device 200, and the leaf pulverizing apparatus 50 is used for mounting a blade 54. In this embodiment, the blade 54 may use a nylon rope. It needs to be noted that the blade 54 may alternatively be a hemp rope, a Kevlar rope, and the like.

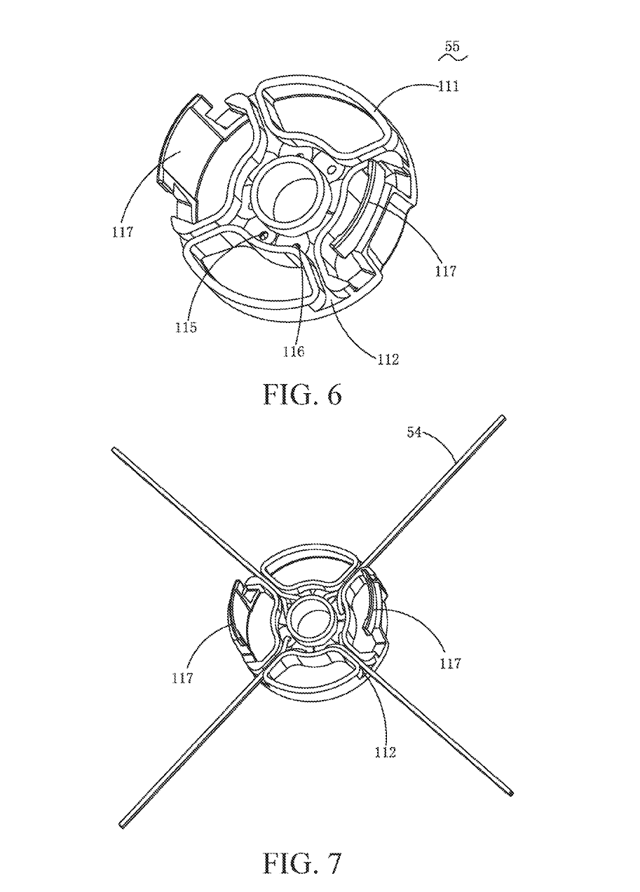

Referring to FIG. 6 then, the mounting cover 55 includes a first surface 111 with a slot 112 formed thereon, with the slot 112 extending to an edge of the first surface 111. The slot 112 is used for clamping the blade 54. In this embodiment, a shape of the mounting cover 55 is a cylinder. There are four slots 112, and the four slots 112 are symmetrically arranged.

In addition, referring to FIG. 5, the mounting cover 55 further includes a second surface 113, and the second surface 113 being opposite to the first surface 111. It can be learned from the above that the shape of the mounting cover 55 is a cylinder, and the first surface 111 and the second surface 113 are located on opposite sides of the cylinder. A first groove 114 is formed on the second surface 113. In this embodiment, there are four first grooves 114, and the four first grooves 114 are symmetrically arranged.

A first through hole 115 and a second through hole 116 are formed on a bottom surface of the first groove 114, as shown in FIG. 6. The first through hole 115 and the second through hole 116 are respectively used for one end of the blade 54 to run through, that is, two ends of the blade 54 respectively run through the first through hole 115 and the second through hole 116. Therefore, the blade 54 becomes two strands, as shown in FIG. 7. The blade 54 running through the first through hole 115 and the second through hole 116 is clamped in the slot 112. Therefore, the blade 54 is fastened in the mounting cover 55.

In the embodiment shown in FIGS. 6 and 7, the slot 112 is located between the first through hole 115 and the second through hole 116. In this way, the blade 54 running through the first through hole 115 and the second through hole 116 can be directly clamped in the slot 112. It needs to be noted that the slot 112 may alternatively be formed at another position, and the blade 54 running through the first through hole 115 and the second through hole 116 is clamped in the closest slot 112.

After the blade 54 is clamped in the slot 112 formed on the first surface 111 of the mounting cover 55, the blade 54 needs to be connected to the rotating disc 51. Specifically, referring to FIG. 5, a fourth groove 511 is formed on the rotating disc 51, and a surface that is of the rotating disc 51 and that is provided with the fourth groove 511 is in contact with and is connected to the first surface 111 of the mounting cover 55. In this way, the blade 54 can be better fastened between the mounting cover 55 and the rotating disc 51. In addition, the motor in the leaf cleaning device 200 is connected to a bottom portion of the fourth groove 511, and the motor drives the rotating disc 51 to drive.

Furthermore, the mounting cover 55 is detachably connected to the rotating disc 51. In this embodiment, the mounting cover 55 is engaged with the rotating disc 51. As shown in FIG. 6, the mounting cover 55 is provided with a protruding portion 117, which extends outward from an edge of the first surface 111. Still referring to FIG. 5, a third groove 512 is formed on an outer surface of the rotating disc 51, the third groove 512 matches the protruding portion 117, and the outer surface of the rotating disc 51 is a circumferential side surface of the rotating disc 51.

In this embodiment, there are two protruding portions 117, and the two protruding portions 117 are symmetrically arranged. Correspondingly, two third grooves 512 are formed on an outer surface of the mounting cover 55, and the two third grooves 512 are symmetrically arranged. It needs to be noted that there may alternatively be one, three, or more protruding portions 117, which may be set according to practical needs.

It needs to be noted that the mounting cover 55 may alternatively be detachably connected to the rotating disc 51 by using another manner, such as a snap-on manner.

In addition, in this embodiment, to better fasten the blade 54 during work and not displace the blade 54, as shown in FIG. 5, a limiting plate 513 is disposed on the bottom portion of the fourth groove 511, the limiting plate 513 extending outward from the bottom portion of the fourth groove 511, with the limiting plate 513 in contact with and connected to an inner wall of the fourth groove 511.

To better limit the blade 54, in this embodiment, a width of the limiting plate 513 is equal to a width of the slot 112. In this way, when the mounting cover 55 is connected to the rotating disc 51, the limiting plate 513 is engaged with the slot 112 to enable the blade 54 to be securely clamped in the slot 112. The width of the limiting plate 513 is the width of the slot 112 and is in a direction perpendicular to the inner wall of the fourth groove 511. It needs to be noted that the width of the limiting plate 513 may alternatively be less than the width of the slot 112.

In this embodiment, a fourth through hole 514 is formed on the bottom portion of the fourth groove 511, an inner wall of the fourth through hole 514 extending along an axial direction of the fourth through hole 514, with cavity 515 being formed. A front end of the output shaft of the motor 40 of the leaf cleaning device 200 may run through the fourth through hole 514, and is fixedly connected to the rotating disc 51 by using a nut. The motor 40 drives the rotating disc 51 to synchronically move.

In this embodiment, the width of the limiting plate 513 is a distance between an outer wall of the cavity 515 and the inner wall of the fourth groove 511. That is, the limiting plate 513 is disposed between the inner wall of the fourth groove 511 and the outer wall of the cavity 515.

In another embodiment, the blade 54 may alternatively be clamped in the slot by using another method. A second groove may be formed on the first surface 111 of the mounting cover 55, and a third through hole is formed on an inner wall of the second groove. In this way, one end of the blade 54 may sequentially run through the third through hole, with the blade 54 being clamped in the slot.

In addition, the slot 112 may alternatively extend to two opposite edges of the first surface 111, with the blade 54 being directly clamped in the slot 112.

The blade 54 is clamped in the leaf pulverizing apparatus 50, and the leaf pulverizing apparatus 50 is disposed in the leaf cleaning device 200. When the blade 54 needs to be replaced, one only needs to take out the leaf pulverizing apparatus 50 to rapidly replace the blade 54.

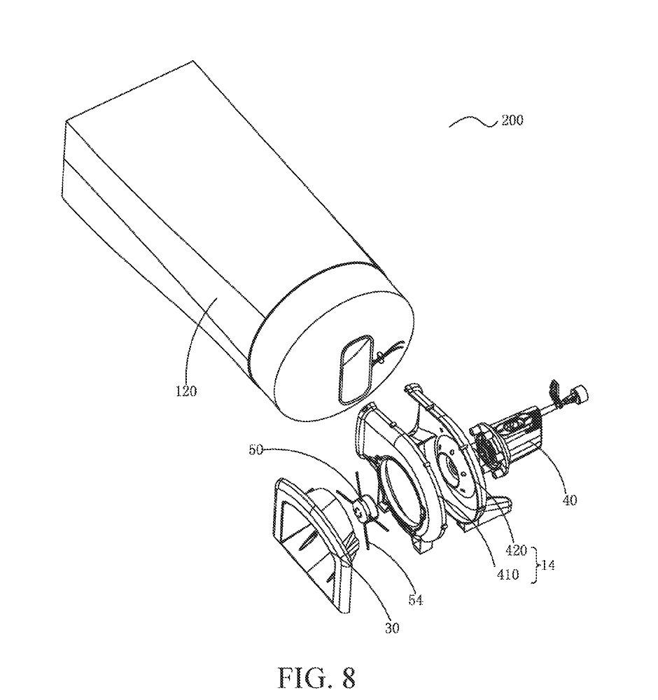

As shown in FIG. 8, a leaf cleaning device 200, according to an embodiment, includes a leaf pulverizing apparatus 50, a blade 54, an air inlet 30, a spiral housing 14, a motor 40, and a leaf collection bag 120. The air inlet 30 is connected to one side of the spiral housing 14, the leaf pulverizing apparatus 50 is disposed in the spiral housing 14, the motor 40 is connected to the other side of the spiral housing 14, a front end of the motor 40 is connected to a rotating disc 51, the motor 40 drives the rotating disc 51 to rotate, and the blade 54 is disposed in the leaf pulverizing apparatus 50.

Specifically, the spiral housing 14 includes an upper housing 410 and a lower housing 420, the air inlet 30 is connected to the upper housing 410, and the leaf pulverizing apparatus 50 is disposed between the upper housing 410 and the lower housing 420. The motor 40 is fixedly connected to the lower housing 420, and a shaft of the motor 40 sequentially runs through the lower housing 420 and a fourth through hole 514 formed on the rotating disc 51. The leaf collection bag 120 is detachably connected to the spiral housing 14. A front end of an output shaft of the motor 40 runs through the fourth through hole 514, and is fixedly connected to the rotating disc 51 by using a nut.

In this way, when the leaf cleaning device 200 works, the motor 40 rotates in a high speed, and the shaft of the motor 40 drives the leaf pulverizing apparatus 50 and the blade 54 to rotate together in a high speed. Leaves and the like enter the spiral housing 14 through the air inlet 30, and after being pulverized by the high-speed rotating blade 54, the pulverized leaves enter the leaf collection bag 120 under action of a centrifugal force.

FIG. 9 shows a leaf pulverizing apparatus 80 in another embodiment. In this embodiment, the leaf pulverizing apparatus 80 includes a rotating disc 82 and a blade 84, the blade 84 is fixedly mounted onto the rotating disc 82, and the rotating disc 82 is provided with a mounting portion 86 fitted to the output shaft 42 of the motor 40. Similarly, the motor 40 drives the rotating disc 82 to rotate, and the rotating disc 82 rotates to drive the blade 84 to rotate, so as to pulverize leaves entering the leaf cleaning device 200.

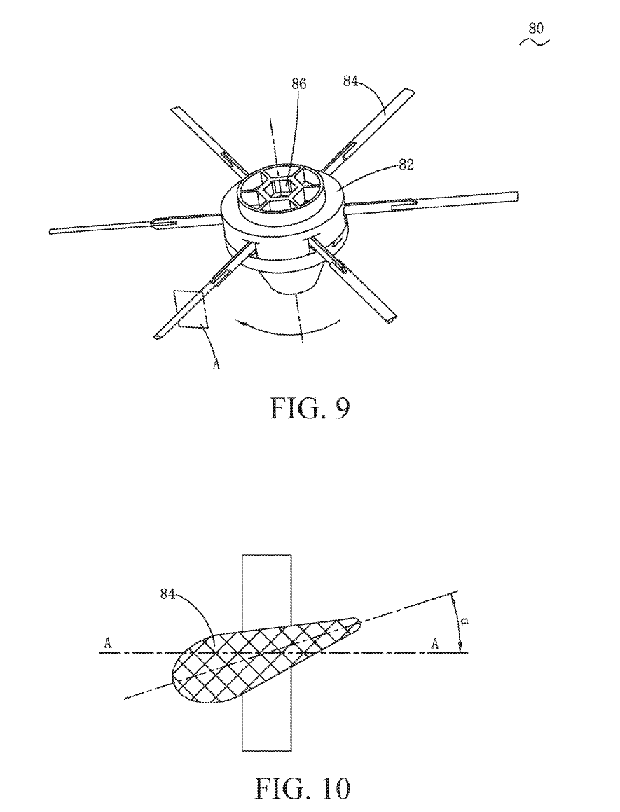

The following is to describe in detail differences between the leaf pulverizing apparatus 80 in this embodiment and that embodiment shown in FIG. 4. FIG. 10 is a schematic diagram of the blade in FIG. 9 after the blade is cut along a cutaway plane A. In FIG. 10, A-A is a rotation plane of the blade 84. To enable the blade 84 to achieve an expected leaf pulverizing effect, a blade angle α between a plane of the blade 84 and the rotation plane of the blade 84 is 0°-30°. Preferably, when the blade angle α is 5°, the efficiency of the blade 84 pulverizing leaves entering the leaf cleaning device 200 is apparently improved.

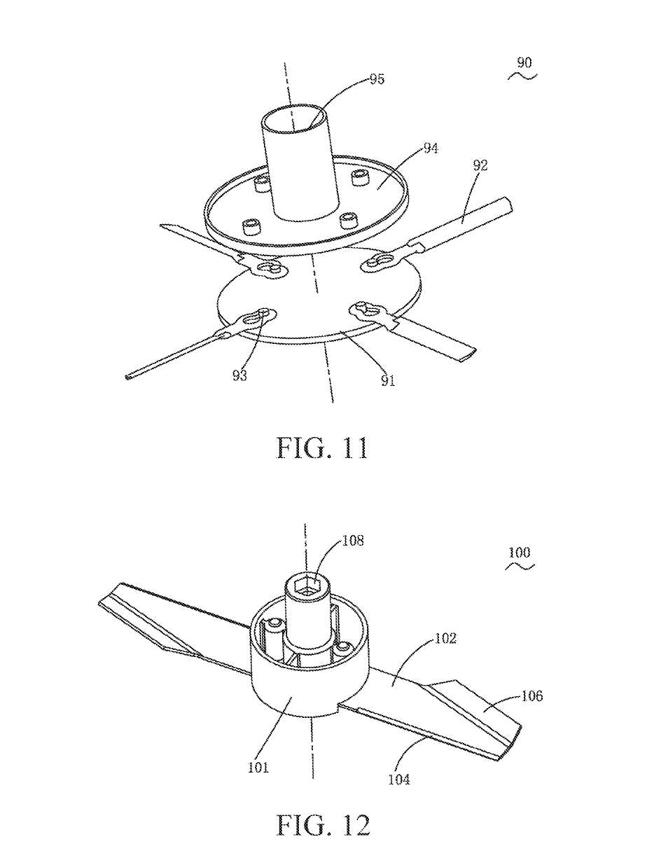

FIG. 11 shows a leaf pulverizing apparatus 90 in another embodiment. The leaf pulverizing apparatus 90 includes a rotating disc 91 and a blade 92. A plurality of connecting shafts 93 are evenly arranged at a position that is close to an edge and that is on the circumference of the rotating disc 91. The blade 92 is connected to the connecting shaft 93, and the blade 92 may rotate perpendicular to an axis direction of the connecting shaft 93. In this embodiment, there are four connecting shafts 93 and, correspondingly, there are four blades 92. A person skilled in the art may understand that in another embodiment, there may be less than or more than four connecting shafts 93, that is, the number of the blades 92 may be set to any number greater than 0. Any arrangement number of the connecting shafts 93 that can implement pulverizing of the leaves entering the leaf cleaning device pertains to the protection idea of this disclosure and falls within the protection scope of this disclosure.

The leaf pulverizing apparatus 90 further includes a mounting cover 94 fitted to the rotating disc 91. After the blade 92 is mounted to the connecting shaft 93, the mounting cover 94 is fitted to the rotating disc 91, so as to fasten the blade 92 and prevent the blade 92 from moving in an up-and-down direction of the connecting shaft 93. A central part of the mounting cover 94 is provided with a mounting portion 95 fitted to the output shaft 42 of the motor 40. The motor 40 drives the rotating disc 91 to rotate, and due to action of a centrifugal force generated by rotation of the rotating disc 91, the blade 92 extends toward the periphery of the rotating disc 91.

In other words, due to the action of the centrifugal force, an extension line in a length direction of the blade 92 extends through a center of the rotating disc 91, and when the blade 92 hits leaves, the leaves are pulverized by the blade 92 due to a high-speed motion of the blade 92. At the same time, because the leaves generate action of a force to the blade 92, the blade 92 may rotate by using the connecting shaft 93 as a center, so that buffer action is generated to the blade 92. Such a design may effectively prevent a rotation speed of the blade 92 from being excessively high, and prevent the blade 92 from being broken.

Further, to reduce damage to the blade 92 during pulverizing leaves, a material of the blade 92 may be an elastic material with certain toughness. When the blade 92 hits the leaves, because the blade 92 is of a flexible elastic material, the blade 92 may be deformed to a certain degree due to the action of a force, and the buffer action is generated to the blade 92, preventing the blade 92 from being broken.

FIG. 12 shows a leaf pulverizing apparatus 100 in another embodiment. The leaf pulverizing apparatus 100 includes a rotating disc 101 and a blade 102 mounted onto the rotating disc 101. The blade 102 includes a pair of cutting edges 104 and a pair of flanges 106. The cutting edges 104 are used for pulverizing leaves entering the inside of the leaf cleaning device 200, and the flanges 106 are disposed for increasing a wind force generated when the blade 102 rotates in order to obtain a better cutting and pulverizing effect. The rotating disc 101 is provided with a mounting portion 108 fitted to the output shaft 42 of the motor 40. The motor 40 drives the blade 102 to rotate, so as to pulverize the leaves entering the leaf cleaning device 200. In this embodiment, the blade 102 uses a metal material, making the blade 102 more solid and abrasion-resistant, and may obtain a longer useful life.

Several embodiments of the pulverizing apparatus are listed above, but this is not a limitation to the protection scope of the pulverizing apparatus of this disclosure. The pulverizing apparatus of this disclosure includes, but is not limited to, the several embodiments of the pulverizing apparatus listed above. A person skilled in the art may imagine that there are some other embodiments of the pulverizing apparatus. Any pulverizing apparatus that can pulverize the leaves entering the leaf cleaning device 200 pertains to the protection idea of this disclosure and falls with the protection scope of the disclosure.

The leaf cleaning device 200 sucks the leaves into the inside of the leaf cleaning device 200 by using the air inlet 30, and pulverizes the leaves by using the leaf pulverizing apparatus. The leaves are eventually discharged by using the air outlet 60 of the leaf cleaning device 200. In this embodiment, the pulverizing apparatus has two functions. First is generating a wind force by means of rotating to lead an air flow to enter the inside of the leaf cleaning device 200 through the air inlet 30 of the leaf cleaning device 200, and to discharge the air flow through the air outlet 60 of the leaf cleaning device 200. Second is pulverizing the leaves entering the inside of the leaf cleaning device 200 through the air inlet 30.

The pulverizing apparatus rotates to generate the wind force to lead the air flow to enter the inside of the leaf cleaning device 200 through the air inlet 30, and the leaves are lead by the air flow to enter the inside of the leaf cleaning device 200. The leaves are pulverized inside the housing 10 by the pulverizing apparatus, and the pulverized leaves rotate to the air outlet 60 under guidance of the air flow that is lead by the wind force generated by the rotation of the pulverizing apparatus, and are eventually discharged through the air outlet 60. In general, the pulverizing apparatus can pulverize the leaves entering the housing 10, and can rotate to generate the air flow to enter the inside of the housing 10 through the air inlet 30 of the leaf cleaning device 200, and to be discharged through the air outlet 60.

In this embodiment, the pulverizing apparatus has dual functions of rotating to generate the air flow that sucks in and then pulverizes the leaves. In another embodiment, the effect of the pulverizing apparatus in this embodiment may be achieved by means of respectively disposing two apparatuses. One of the apparatuses, for example, a centrifugal fan, only has the effect of enabling the air flow to enter the inside of the leaf cleaning device 200 through the air inlet 30 of the leaf cleaning device 200 and to be discharged through the air outlet 60. The other one of the apparatuses only has the function of pulverizing the leaves sucked into the inside of the leaf cleaning device 200. Certainly, it may be said that one apparatus only has the function of pulverizing the leaves and the corresponding other one has the dual functions of pulverizing the leaves and generating the air flow. A person skilled in the art may imagine that except the several methods listed above, there may be another combination method to pulverize the leaves and generate the air flow. Any implementation that can achieve the dual functions of pulverizing the leaves and generating the air flow and that does not depart from the core concept of the disclosure falls within the protection scope of this disclosure.

The fundamental functions of the leaf cleaning device 200 are to suck the leaves into the inside of the leaf cleaning device 200, to pulverize the leaves sucked inside, and eventually to discharge the pulverized leaves through the air outlet. So long as the fundamental functions of the leaf cleaning device 200 are achieved, arrangement of the leaf pulverizing apparatus and the apparatus for generating a suction wind force, and the number and form of the set apparatuses are not strictly limited, and all fall with the protection scope of this disclosure.

The following is to describe in detail the working principle of the leaf cleaning device 200 in this disclosure and optimized designs. A user uses the leaf cleaning device 200 to remove fallen leaves on a lawn, and the user may place, by using the support portion 70, the leaf cleaning device 200 of this disclosure on the ground to perform a fallen leaf removal operation, so as to avoid a working load that a common leaf cleaning device needs to be held to perform an operation. In this disclosure, the support portion 70 is a portion that is of the first extending portion 16 and that is in contact with the ground when the leaf cleaning device 200 is working. In another embodiment, alternatively, an independent support component may additionally be disposed besides the leaf cleaning device 200.

The leaf cleaning device 200 is turned on, and the motor 40 is powered on and rotates to drive the leaf pulverizing apparatus connected to the motor 40 to rotate. The leaf pulverizing apparatus rotates to lead the air flow to enter the inside of the machine through the air inlet 30 of the leaf cleaning device 200, and after being pulverized by the leaf pulverizing apparatus, the leaves are eventually discharged from the air outlet 60 of the leaf cleaning device 200. In this disclosure, the leaf cleaning device 200 is placed on the ground for use and, when removing leaves on the lawn that are around the leaf cleaning device 200, the user may move the leaves around the leaf cleaning device 200 to a position close to the air inlet 30 of the leaf cleaning device 200 by using some auxiliary instruments such as a rake. The leaves eventually enter the inside of the leaf cleaning device 200 under the action of the air flow, are pulverized, and are discharged through the air outlet 60 of the leaf cleaning device 200. Certainly, in another embodiment, rather than being lead by the air flow, the leaves may be directly pushed into the inside of the leaf cleaning device 200 by using the auxiliary tool such as the rake, and are eventually discharged through the air outlet 60 of the leaf cleaning device 200.

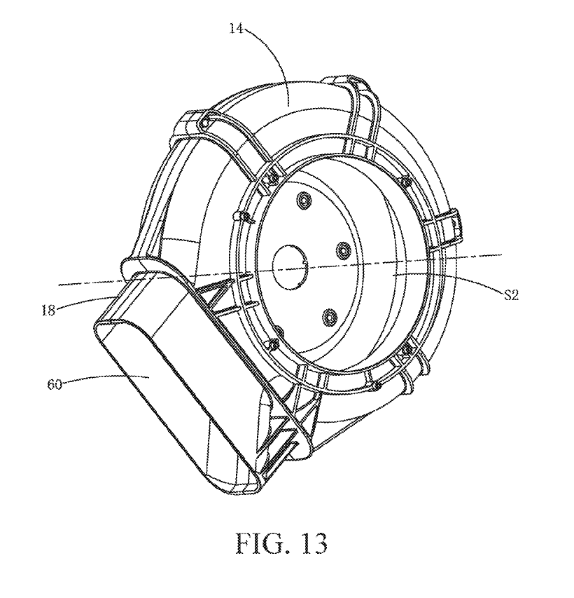

Referring to FIGS. 1 and 13, the leaves enter the inside of the leaf cleaning device 200 through the air inlet 30. To ensure the leaves enter smoothly into the inside of the housing 10 of the leaf cleaning device 200 through the air inlet 30, an air vent area 51 of the air inlet 30 is greater than 260 square centimeters and, further, the air vent area 51 of the air inlet 30 is equal to or less than 800 square centimeters. This may ensure that in a period of time, sufficient leaves are sucked into the housing so as to improve the leaf pulverizing efficiency. In the most preferred embodiment, the air vent area S1 of the air inlet 30 is about 500 square centimeters. In this embodiment, the air inlet 30 is in a shape of a rectangular opening and has an air vent length L and an air vent height H. Experiments verify that when the air inlet 30 has the air vent length L-to-the air vent height H ratio in a range of greater than 0.5 and less than 2, the efficiency of leaves passing through the air inlet 30 is higher. In a preferred embodiment, the air vent length L is preferably 240 mm, and the air vent height H is preferably 160 mm. In this case, the air vent has a length-to-width ratio of 1.5. Certainly, the air inlet 30 may be rotated by 90 degrees. In this case, the length is 160 mm, the height is 240 mm, and the air vent has a length-to-width ratio of 0.67. Such a setting of the value of the air vent area S1 and a setting of the air vent length L-to-the air vent height H ratio of the air inlet 30 comprehensively take into account a common lawn leaf size and the number of leaves entering the air inlet of the leaf cleaning device 200 in unit time, to ensure that the leaves can smoothly enter the inside of the machine through the air inlet 30 of the leaf cleaning device 200, and congestion does not occur. When the leaf cleaning device 200 is placed on the ground for user, a distance between a lower end portion of the air inlet 30 of the leaf cleaning device 200 and the ground is less than 2 cm. Such a value setting avoids that the air inlet 30 is too far away from the ground and the suction force of the air inlet 30 is affected, so that the leaf suction effect of the leaf cleaning device 200 is well ensured.

The leaves sucked into the air inlet 30 of the leaf cleaning device 200 move along the first extending portion 16 to the spiral housing 14 of the leaf cleaning device 200, and enter the inside of the spiral housing 14 through a communication end between the first extending portion 16 and the spiral housing 14. To ensure that after entering the first extending portion 16 through the air inlet 30 the leaves can smoothly enter the inside of the spiral housing 14 together with the air flow, a range of a communication area S2 of an end that is of the first extending portion 16 and that is in communication with the spiral housing 14 is greater than 95 square centimeters. Such a design comprehensively takes into account the number of leaves passing through the end that is of the first extending portion 16 and that is in communication with the spiral housing 14 in unit time, so that the congestion will not occur at a communication portion between the first extending portion 16 and the spiral housing 14, thereby improving the efficiency of leaves passing through.

The leaves entering the inside of the leaf cleaning device 200 through the air inlet 30 of the leaf cleaning device 200 move along the first extending portion 16 to the spiral housing 14, and the range of the communication area S2 of the end that is of the first extending portion 16 and that is in communication with the spiral housing 14 is defined before, to ensure the leaves sucked in can smoothly enter the inside of the spiral housing 14. Similarly, to improve the efficiency of leaves moving along the first extending portion 16 from the air inlet 30 to the spiral housing 14, the first extending portion 16 has the first end connected to the center of the spiral housing 14 and the second end connected to the air inlet 30, and a cross-sectional area of the first end of the first extending portion 16 is smaller than a cross-sectional area of the second end. The first extending portion 16 has a gradually increasing cross-sectional area from the first end to the second end. Preferably, the first extending portion 16 is overall in a shape of a trapezoid, the first end being located at the shorter top portion of the trapezoid, and the second end being located at the longer bottom portion of the trapezoid. That is, a cross-sectional area of any cross section of the first extending portion 16 between the end connected to the air inlet 30 and the end in communication with the spiral housing 14 is not smaller than the communication area S2 of the end that is of the first extending portion 16 and that is in communication with the spiral housing 14. This ensures the smallest cross-sectional area when the leaves move along the first extending portion 16, improves the environment of the leaves moving along the first extending portion 16, and increases the efficiency of the leaves being sucked in and entering the inside of the spiral housing 14.

The housing 10 of the leaf cleaning device 200 is further provided with a handle (not shown) extending upward along a vertical direction. The handle is disposed for a user to hold to move the leaf cleaning device 200 when the user needs to store the leaf cleaning device 200 after use, or when the user needs to move the leaf cleaning device 200 when performing a leaf removal operation, thereby facilitating an operation of the user.

In this disclosure, the leaf cleaning device 200 includes the air inlet 30 for sucking the leaves inside, and the air outlet 60 for discharging the leaves pulverized by the leaf pulverizing apparatus from the leaf cleaning device 200. An extending direction of the air inlet 30 is parallel to an extending direction of the air outlet 60, and the air inlet 30 is located below the air outlet 60. The air inlet 30 and the air outlet 60 are respectively located on two opposite sides of the housing 10 of the leaf cleaning device 200. Such a design helps to improve the efficiency of the leaves being pulverized and being discharged through the air outlet 60 after the leaves enter the inside of the housing 10 of the leaf cleaning device 200, so that the leaves enter more smoothly through the air inlet 30 and are more smoothly discharged through the air outlet 60.

In this embodiment, a direction of the output shaft 42 of the motor 40 is perpendicular to the ground, and a rotation axis of the leaf pulverizing apparatus is also perpendicular to the ground. In this way, the design of a position of the motor 40 and a position of the leaf pulverizing apparatus is not a strict limitation to specific arrangement positions of the motor 40 and the leaf pulverizing apparatus. A person skilled in the art may imagine that the motor 40 and the leaf pulverizing apparatus may alternatively be located at other positions, and a simple position change does not depart from the protection essence of this disclosure, and falls within the protection scope of this disclosure.

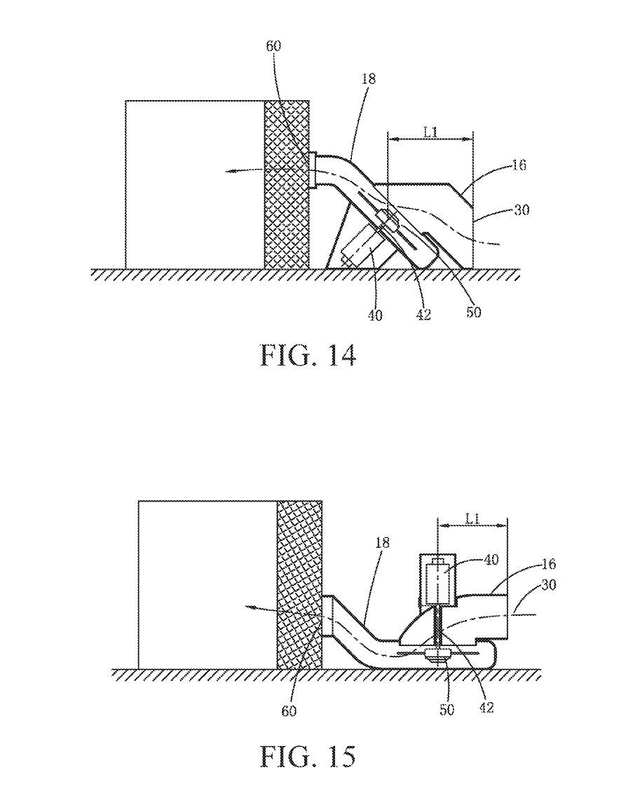

In an embodiment shown in FIG. 14, an output shaft 42 of a motor 40 coincides with a rotation axis of a leaf pulverizing apparatus 50, and the output shaft 42 and the rotation axis of the leaf pulverizing apparatus 50 are disposed at an angle to the ground. In this embodiment, an extending direction of an air outlet 60 of a leaf cleaning device 200 is parallel to an extending direction of an air inlet 30 of the leaf cleaning device 200, with the air outlet 60 being located above the air inlet 30. Leaves enter the inside of the leaf cleaning device 200 through the air inlet 30, and are discharged through the air outlet 60 after being pulverized by the leaf pulverizing apparatus 50 that is obliquely disposed. A setting of a position of the air outlet 60 takes into account a position of obliquely disposing the leaf pulverizing apparatus 50, and the air outlet 60 is disposed in a direction of discharging an air flow generated by rotation of the leaf pulverizing apparatus 50. Such a setting may ensure that the leaves entering the air inlet 30 of the leaf cleaning device 200 can be smoothly discharged through the air outlet 60 after being pulverized.

This embodiment shown in FIG. 14 may alternatively have the following change. An upper portion of a first extending portion 16 may be removed to only keep a lower portion of the first extending portion 16. In this case, a shape of the extending portion 16 is similar to a slide in an amusement park. When using the leaf cleaning device 200 to suck in and pulverize leaves, a user can see a working status of the leaf pulverizing apparatus, so that the user can easily avoid touching the leaf pulverizing apparatus, thereby eventually protecting the operational safety of the user.

In an embodiment shown in FIG. 15, a direction of an output shaft 42 of a motor 40 coincides with a direction of a rotation axis of a leaf pulverizing apparatus 50, and the direction of the output shaft 42 of the motor 40 and the direction of the rotation axis of the leaf pulverizing apparatus 50 are both perpendicular to the ground. In this embodiment, an extending direction of an air inlet 30 of a leaf cleaning device 200 and an extending direction of an air outlet 60 of the leaf cleaning device 200 are both parallel to the ground, and a rotation plane of the leaf pulverizing apparatus 50 is located below the air inlet 30 of the leaf cleaning device 200.

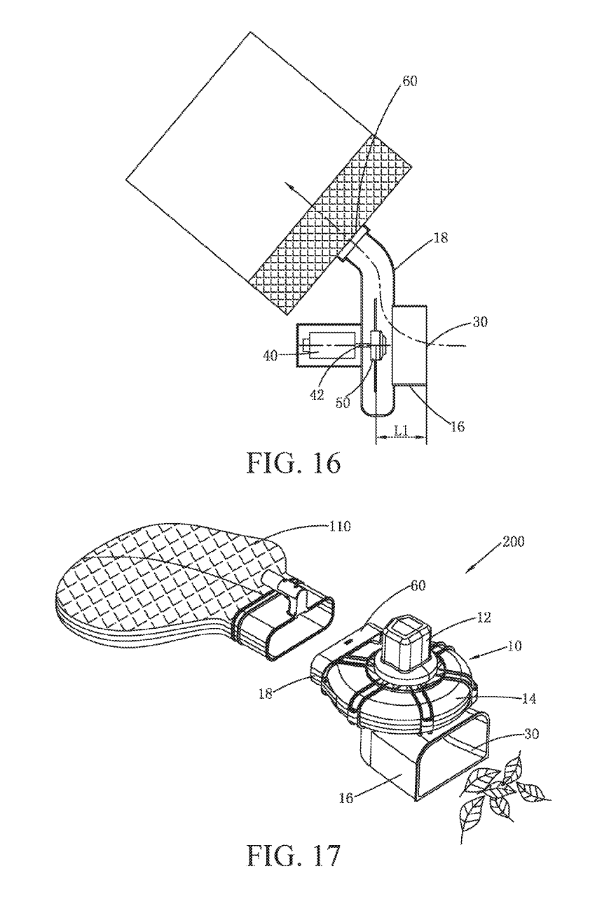

FIG. 16 shows a corresponding embodiment from a top perspective. An axis direction of an output shaft 42 of a motor 40 coincides with a direction of a rotation axis of a leaf pulverizing apparatus 50, and the axis direction of the output shaft 42 of the motor 40 and the direction of the rotation axis of the leaf pulverizing apparatus 50 are both parallel to ground. An extending direction of an air inlet 30 crosses an extending direction of an air outlet 60, the air outlet 60 being disposed to bend toward the left, and located on the left side of the air inlet 30. Leaves enter the inside of a housing 10 of a leaf cleaning device 200 through the air inlet 30, and are discharged through the air outlet 60 after being pulverized by the leaf pulverizing apparatus 50. The air outlet 60, being bent toward the left, may enable the air outlet 60 to be away from the air inlet 30, so that when a user stands at the air inlet 30 and pushes leaves on a lawn into the air inlet 30 by using an auxiliary tool such as a rake, pulverized leaves and dust that are discharged through the air outlet 60 will not get in contact with the user, and operational health of the user is ensured.

This embodiment shown in FIG. 16 may alternatively have the following change. A first extending portion 16 of the leaf cleaning device 200 may be entirely removed, and only the spiral housing 14 is kept. In this way, when using the leaf cleaning device 200 to suck in and pulverize leaves on the ground, the user can clearly see a working status of the leaf pulverizing apparatus, so that the user can easily avoid touching the leaf pulverizing apparatus, thereby eventually protecting the operational safety of the user.

A person skilled in the art may imagine that there are multiple implementations of the arrangement positions of the motor 40, the leaf pulverizing apparatus, the air inlet 30, and the air outlet 60 of the leaf cleaning device 200, which are not listed herein one by one. Any arrangement form that can suck the leaves into the inside of the leaf cleaning device 200 through the air inlet 30, pulverize the leaves inside the leaf cleaning device 200 by using the leaf pulverizing apparatus, and discharge the leaves through the air outlet 60 falls within the protection scope of this disclosure.

Referring to FIGS. 7, 14, 15, and 16, the leaf pulverizing apparatus 50 of the leaf cleaning device 200 includes a rotating disc, with a central part of the rotating disc being fitted to the output shaft 42 of the motor 40. A horizontal distance L1 between the center of the rotating disc and the air inlet 30 of the leaf cleaning device 200 is less than 30 cm. That is, a distance between the leaf pulverizing apparatus 50 and the air inlet 30 is less than 30 cm. In a preferred embodiment, the distance is less than 20 cm. A setting of the horizontal distance L1 between the center of the rotating disc and the air inlet of the leaf cleaning device 200 mainly takes content of two aspects into account, namely, ensuring a suction force and subsequent events of the abrasion of the leaf pulverizing apparatus. The following describes the content of the two aspects in detail.

1. Such a design of the horizontal distance L1 of less than 30 cm may enable the distance between the leaf pulverizing apparatus and the air inlet 30 of the leaf cleaning device 200 to be limited in a range. In this disclosure, a wind force generated by rotation of the leaf pulverizing apparatus leads an air flow to enter the inside of the leaf cleaning device 200 through the air inlet 30, and to be eventually discharged through the air outlet of the leaf cleaning device 200. The distance between the leaf pulverizing apparatus and the air inlet 30 is set to be smaller, which may effectively improve the strength of the air flow entering the air inlet 30. In other words, the suction force at the air inlet 30 is stronger, so that the leaf cleaning device 200 has a better leaf suction effect.

2. The leaves on the lawn enter the inside of the leaf cleaning device 200 through the air inlet 30, and are discharged through the air outlet 60 of the leaf cleaning device 200 after being pulverized by the leaf pulverizing apparatus. During use, the leaf pulverizing apparatus collides with a large number of leaves and pulverizes the leaves. Long time of use may cause normal abrasion to the leaf pulverizing apparatus, and once the abrasion occurs to the leaf pulverizing apparatus, the suction force of the leaf pulverizing apparatus is reduced.

As compensation, the horizontal distance L1 between the center of the rotating disc and the air inlet of the leaf cleaning device 200 is less than 30 cm, and a suction tube is set to be shorter. In this case, the user may directly push, by using a rake or some other auxiliary tools, the leaves into the spiral housing 14 to be pulverized by the pulverizing apparatus, so as to compensate for a defect resulting from long-time use of the leaf pulverizing apparatus, causing abrasion to occur and the suction force to be reduced.

The leaves on the lawn are sucked into the inside of the housing 10 of the leaf cleaning device 200 through the air inlet 30 of the leaf cleaning device 200, and after being pulverized inside the housing 10 by the leaf pulverizing apparatus, the leaves are lead by the air flow to be eventually discharged through the air outlet 60 of the leaf cleaning device 200. To avoid affecting the landscape and difficult subsequent cleaning resulting from randomly discharging the pulverized leaves onto the lawn, a user generally connects a leaf collection bag 110 to the air outlet 60 of the leaf cleaning device 200 to collect the leaves that are discharged after being pulverized. As shown in FIG. 17, after the leaves are collected by using the leaf collection bag 110, the user may empty the leaf collection bag filled with the leaves into a trash can or a dedicated trash recovery bag.

In this disclosure, there are multiple forms of the leaf collection bag 110. In another embodiment, the leaf collection bag 110 is made of an air-permeable material, such as a cloth or a fabric product. The leaf collection bag 110 is connected to the air outlet 60 of the leaf cleaning device 200 by using a rapid removal method. The rapid removal method may help the user to rapidly mount the leaf collection bag 110 to the air outlet of the leaf cleaning device 200, and to rapidly remove the leaf collection bag 110 from the air outlet 60 of the leaf cleaning device 200, thereby saving time, and being convenient and simple to use.

There are multiple rapid removal methods, for example, connecting by using a snap-on method or by using an elastic ribbon, or tying up by using a rope. Certainly, a person skilled in the art may imagine that methods to implement the rapid removal include, but are not limited to, the several forms listed above. Any connecting method that can implement the rapid removal does not depart from the protection idea of this disclosure, and falls within the protection scope of this disclosure.

The leaf collection bag 110 uses an air-permeable material, so that after the pulverized leaves and the air flow enter the leaf collection bag 110 through the air outlet 60 of the leaf cleaning device 200, the air flow is discharged from the leaf collection bag 110 because the leaf collection bag 110 is made of the air-permeable material, but the pulverized leaves are left in the leaf collection bag 110, allowing the user to dump the leaves collected inside the leaf collection bag 110 into a trash can.

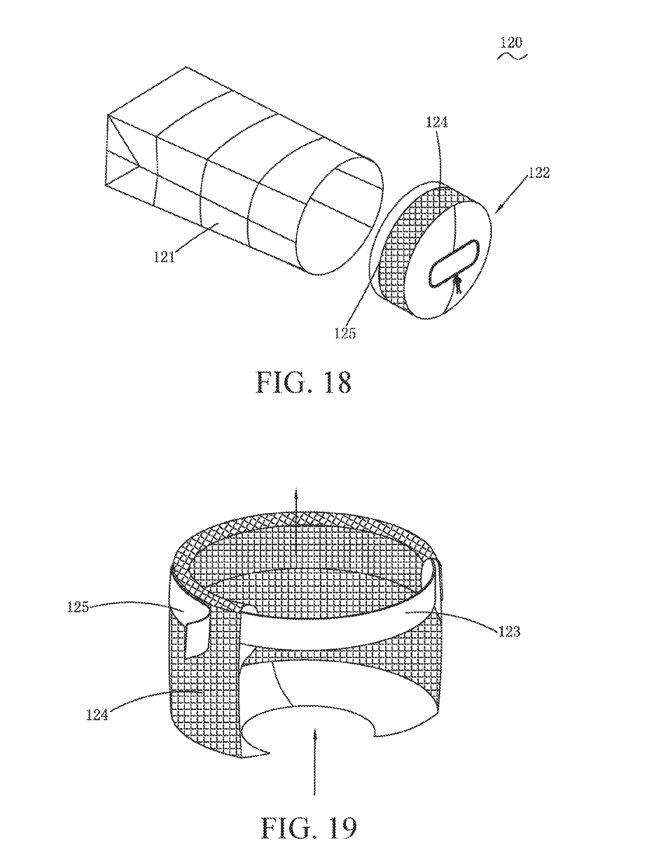

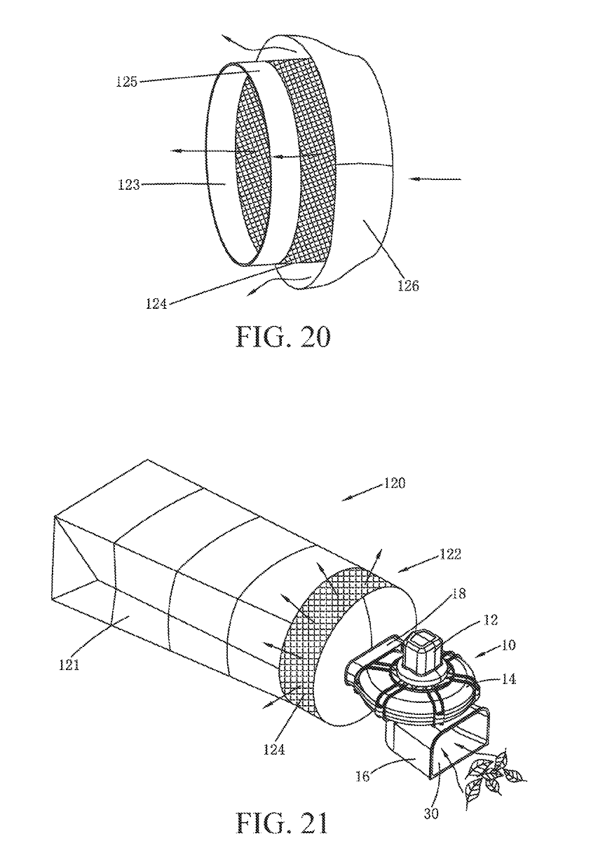

FIGS. 18 to 20 show a leaf collection bag 120 in another embodiment. Arrows in FIGS. 19 and 20 show entry and exit directions of leaves pulverized by the leaf pulverizing apparatus of the leaf cleaning device 200.

The leaf collection bag 120 includes a disposable standard trash recovery bag 121, and the standard trash recovery bag 121 may be of a paper material, or of a plastic material. After the pulverized leaves are collected in the standard trash recovery bag 121, the user may dispose the entire standard trash recovery bag 121 as trash, and does not need to dump the pulverized leaves in the standard trash recovery bag 121 into a trash can. However, when collecting by using a cloth bag and other conventional materials, the user is required to dump the collected leaves into the trash can, making the procedure complex and allowing dust to fly, consequently, affecting the environment and the user's health.

In this embodiment, the leaf collection bag 120 further includes an auxiliary mounting member 122 used in coordination with the standard trash recovery bag 121. The auxiliary mounting member 122 includes an elastic annular member 123, and a fence 124 that is connected to the annular member 123 and is made of a circle of air-permeable material. One end of the fence 124 is connected to the annular member 123, and the other end is connected to the air outlet 60 of the leaf cleaning device 200 by using the rapid removal method. The rapid removal method includes, but is not limited to, a snap-on form, tying up by using a rope, or the like. The foregoing already describes the rapid removal method in detail, and the rapid removal method is not further described herein again.

During use, the elastic annular member 123 is compressed at first, then the auxiliary mounting member 122 is put into the disposable standard trash recovery bag 121, and then the elastic annular member 123 is released. In this case, the elastic annular member 123 returns to an original shape, and when returning to the original shape, the elastic annular member 123 simultaneously opens a bag mouth of the disposable standard trash recovery bag 121. To improve the fixing effect of the opened elastic annular member 123 on a shape of the disposable standard trash recovery bag 121, preferably, a rubber strip 125 is added to an outer circumference of the fence 124 of the auxiliary mounting member 122.

Certainly, in another embodiment, a protrusion or the like may alternatively be added to the outer circumference of the fence 124 of the auxiliary mounting member 122. The adding of the rubber strip or the protrusion is to increase friction between the auxiliary mounting member 122 and the disposable standard trash recovery bag 121, so as to prevent the auxiliary mounting member 122 from being separated from the standard trash recovery bag 121, thereby improving the method of fixing the shape of the disposable standard trash recovery bag 121. A person skilled in the art may imagine that there are multiple methods for increasing the friction including, but not limited to, using the rubber strip or the protrusion. Another method that can increase the friction pertains to the inventive idea of this disclosure, and falls within the protection scope of the disclosure.

One end of the auxiliary mounting member 122 is fastened to the disposable standard trash recovery bag 121 by using the elastic annular member 123, and the other end is rapidly mounted to the air outlet 60 of the leaf cleaning device 200 by using the rapid removal method. The leaves on the lawn are sucked into the inside of the housing 10 of the leaf cleaning device 200 through the air inlet 30, are discharged into the fence 124 of the auxiliary mounting member 122 through the air outlet 60 of the leaf cleaning device 200 after being pulverized by the leaf pulverizing apparatus, continue to move forward under the lead of the air flow, and eventually enter the inside of the disposable standard trash recovery bag 121.

Because the fence 124 of the auxiliary mounting member 122 uses air-permeable material, after the air flow and the pulverized leaves enter the auxiliary mounting member 122, the air flow is discharged from the fence 124 of the auxiliary mounting member 122, and the pulverized leaves eventually enter the inside of the disposable standard trash recovery bag 121. After the leaf processing operation is completed, the user removes one end of the auxiliary mounting member 122 from the air outlet 60 of the leaf cleaning device 200, and then the user compresses the elastic annular member 123 inside the disposable standard trash recovery bag 121, and after compressing the elastic annular member 123, takes out the elastic annular member 123 from the disposable standard trash recovery bag 121. In general, the auxiliary mounting member 122 plays a role of connecting the disposable standard trash recovery bag 121 and the air outlet 60 of the leaf cleaning device 200.

The pulverized leaves are discharged through the air outlet 60 of the leaf cleaning device 200 and enter the inside of the auxiliary mounting member 122. The fence 124 of the auxiliary mounting member 122 is made of an air-permeable material, and the air flow is discharged through the fence 124. When being discharged, the air flow also allows dust to be discharged through the fence 124 and, consequently, the dust easily flies, affecting the environment and the user's health.

Therefore, preferably, a block portion 126 is mounted along the circumference of the fence 124 of the auxiliary mounting member 122. The block portion 126 uses an airtight material, and the disposing of the block portion 126 may block the dust discharged through the fence 124 from flying and affecting the environment and the user's health, without affecting the air flow to be discharged through the fence 124. Certainly, a person skilled in the art may imagine that there are multiple specific forms of the block portion 126. Any form of the block portion 126 that can block the dust discharged through the fence 124 to prevent the dust from flying pertains to the inventive concept of this disclosure, and falls within the protection scope of the disclosure.

FIG. 21 is a state diagram of collecting pulverized leaves after the leaf collection bag 120 is fitted to the air outlet 60 of the leaf cleaning device 200. The block portion 126 blocking the fence 124 is not shown in FIG. 21.

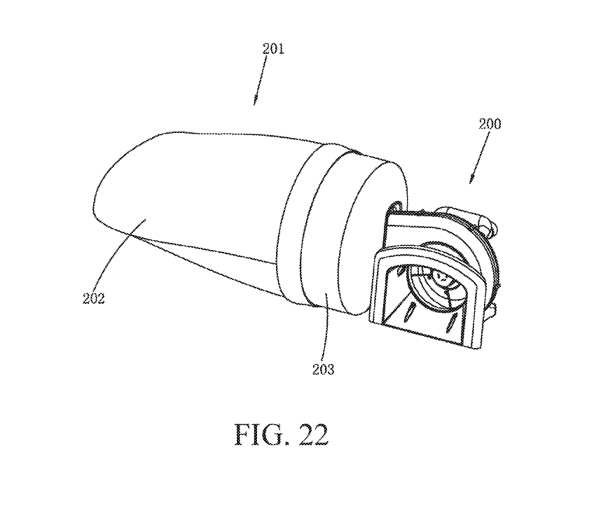

FIGS. 22 to 25 show a leaf collection bag 201 of another embodiment.

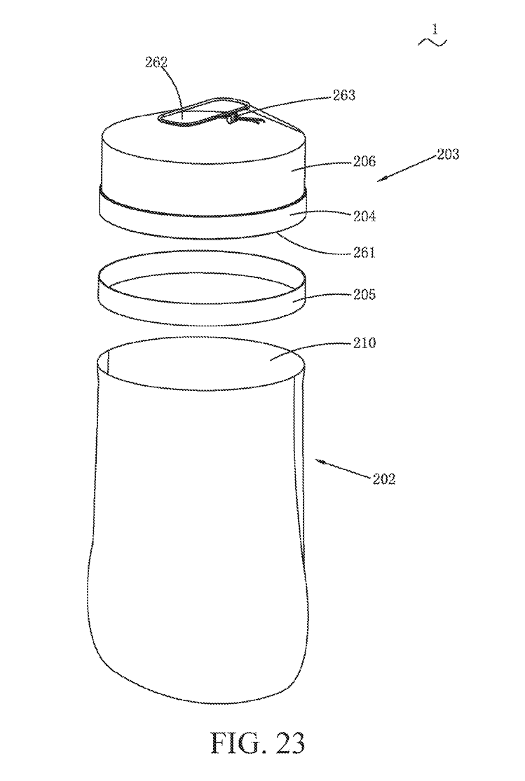

As shown in FIGS. 22 and 23, the leaf collection bag 201 mainly includes a collection bag 202 for collecting leaves, and a mounting assembly 203 respectively connected to the collection bag 202 and the leaf cleaning device 200. The collection bag 202 is a hollow and airtight bag, and has only one bag mouth 210 in communication with the outside. The bag mouth 210 is flexible, and a bag mouth area may change in a range. The leaves enter the inside of the collection bag 202 through the bag mouth 210. In this preferred embodiment, the collection bag 202 is a plastic bag. A material of the plastic bag may be PE, PVC, PP, or the like. A thickness of the plastic bag is generally less than 0.1 mm and, in a preferred embodiment, the thickness of the plastic bag is about 0.025 mm. The costs of the plastic bag are lower, and the airtightness is relatively good, so that leaves are not likely to escape.

In addition to assisting to connect the collection bag 202 to the leaf cleaning device 200, the mounting assembly 203 has a further function of guiding the air circulation. Therefore, the mounting assembly 203 includes an air-permeable portion 206, and the air circulates in and out of the mounting assembly 203 by using the air-permeable portion 206. To increase the circulation efficiency, a main body of the mounting assembly 203 is the air-permeable portion 206.

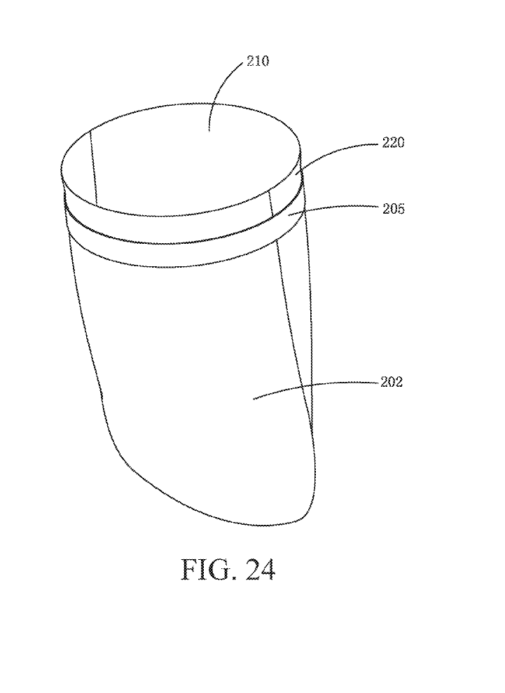

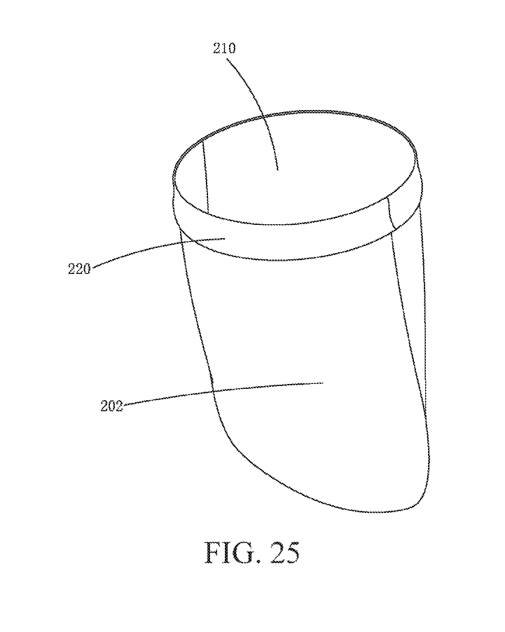

Because the collection bag 202 is relatively flexible, a surface of the collection bag 202 is likely to deform and even rupture after being stretched. To connect to the collection bag 202 in a sealing manner, the mounting assembly 203 is provided with an inner ring and an outer ring in coordination with each other. One of the inner ring and the outer ring is connected to the bag mouth 210 of the collection bag 202. The other one of the inner ring and the outer ring is connected to the air-permeable portion 206, and the inner ring and the outer ring circumferentially abut against each other, so as to enable the mounting assembly 203 to connect to the bag mouth 210 of the collection bag 202. In a preferred embodiment, the inner ring is an annular elastic member 204, which can generate radially outward bias pressure so as to enable the annular elastic member 204 to coordinate with the outer ring. In this embodiment, the annular elastic member 204 is connected to the air-permeable portion 206. The mounting assembly 203 further includes an annular hoop 205 mounted at the bag mouth 210 of the collection bag 202. The annular hoop 205 is made of a hard material, and a hardness of the annular hoop 205 is much larger than a hardness of the collection bag 202. Mounting the annular hoop 205 at the bag mouth 210 may play a role of supporting the bag mouth 210. An area inside the annular hoop 205 is used for leaves to pass through the bag mouth 210. In a preferred embodiment, the annular hoop 205 and the collection bag 202 may be separately disposed. In this way, when not being used, the collection bag 202 is convenient to be folded and stored. When the collection bag 202 needs to be used, the annular hoop 205 may be mounted onto the collection bag 202. A specific mounting method is as follows. As shown in FIGS. 24 and 25, the annular hoop 205 is placed at a position of the bag mouth 210, a bag mouth edge 220 of the collection bag 202 may be folded to wrap the annular hoop 205, so that the relative positions of the annular hoop 205 and the bag mouth 210 are fixed.

At the same time, the annular elastic member 204 abuts against the annular hoop 205 by using the generated bias pressure, so that the mounting assembly 203 is fixedly connected to the collection bag 202 by using coordination between the annular elastic member 204 and the annular hoop 205. A radius of the annular elastic member 204 is roughly the same as a radius of the annular hoop 205. The user compresses the annular elastic member 204 to put the annular elastic member 204 into a space of a radial inner side of the annular hoop 205, and then releases the annular elastic member 204 to enable a radial outer side of the annular elastic member to match the radial inner side of the annular hoop 205 in shape by using an elastic returning force of the annular elastic member 204. In this way, collection bags 202 of various bag mouth sizes can be connected to a same mounting assembly 203 by using the coordination between the annular elastic member 204 and the annular hoop 205, improving the adaptation generality.

In a preferred embodiment, a surface of the air-permeable portion 206 is of a cloth structure, and a surface of the cloth structure has air holes that can facilitate the air circulation but prevent the leaves from passing through. Specifically, the cloth structure may be a material such as a non-woven cloth, or a mesh cloth. After the mounting assembly 203 is respectively connected to the collection bag 202 and the leaf cleaning device 200, a mixture of the air and leaves generated by the leaf cleaning device passes through the mounting assembly 203, the air in the mixture is discharged to the outside by using the air-permeable portion 206, and the leaves are transported to the collection bag 202 to be collected, thereby effectively separating the leaves from the air, improving collection efficiency.

The air-permeable portion 206 has a first opening 261 and a second opening 262 that are through. The first opening 261 is connected to the collection bag 202, and the second opening 262 is connected to the leaf cleaning device 200. The leaves move from the second opening 262 to the first opening 261 and enter the collection bag 202. The air passes through the second opening 262 and is discharged from the air-permeable portion 206, but does not pass through the first opening 261. As shown in FIGS. 20 and 21, the annular elastic member 204 is mounted at the first opening 261. Preferably, the first opening 261 has a flange, and the flange may wrap the annular elastic member 204 to enable the annular elastic member 204 to not be directly in contact with the annular hoop 205. The second opening 262 is provided with a tightening band 263. The tightening band 263 may be selectively tightened or released, so as to conveniently adjust an area of the second opening 262. The mounting assembly 203 may be connected to leaf cleaning devices 200 having different opening sizes.

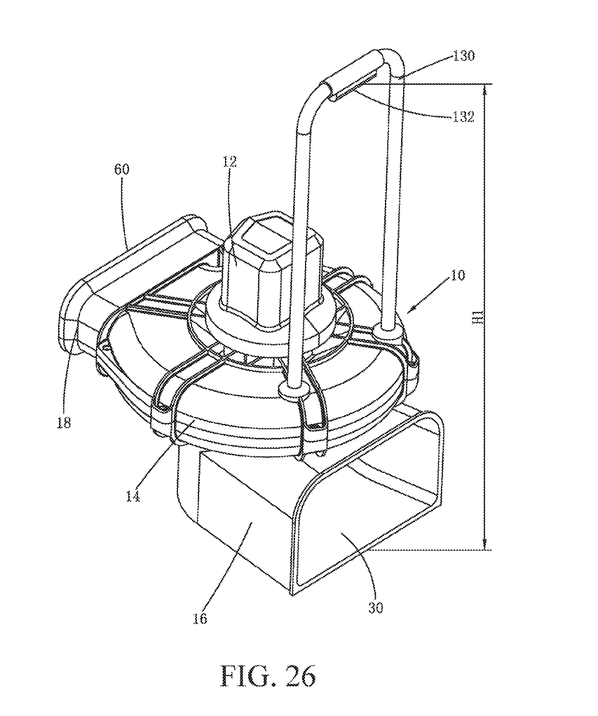

Referring to FIG. 26, the housing 10 of the leaf cleaning devices 200 is further provided with a control rod 130 extending upward. The control rod 130 is provided with a control switch 132, and the control switch 132 is electrically connected to the motor 40 to control the on and off of the motor 40.

In this embodiment, a shape of the control rod 130 is a U shape. Two free ends of the control rod 130 are connected to the housing 10, and the control switch 132 is disposed at a connecting end in the middle of the U-shaped control rod. In another embodiment, the control rod 130 may alternatively be an independent vertical rod extending upward, and the control switch 132 is mounted at an upper end of the vertical rod.

Certainly, a person skilled in the art may imagine that the shape of the control rod 130 is not limited to the vertical rod and the U-shaped rod mentioned above. Another control rod that is connected to the housing 10, that extends upward, and that can control the control switch 132 pertains to the protection idea of this disclosure, and falls within the protection scope of this disclosure.

A reset mechanism is disposed inside the control switch 132. When the control switch 132 is under a force and is in a pressed state, the control switch 132 enables an electrical connection between the control switch 132 and the motor 40, and the motor 40 is started. When pressure on the control switch 132 is canceled, the control switch 132 returns to an original state under an action of the reset mechanism, the electrical connection between the control switch 132 and the motor 40 is disabled, and the motor stops operating. A switch of this type pertains to the technology known by a person skilled in the art, and the implementation principle and specific structure of the switch of this type are not further described in detail.

When the leaf cleaning device 200 is placed on the ground to perform the leaf removal operation, a range of a switch height H1 between the control switch 132 on the control rod 130 and the ground is 70 to 100 cm. Selection of a value of the height between the control switch 132 and the ground mainly takes the operation comfort into account. When the control switch 132 is disposed too high, the user needs to raise an arm to hold the control switch 132. Because the leaf cleaning device needs to be kept operating, the user needs to continuously hold and press the control switch 132. The user is likely to suffer from fatigue, and the operation is very uncomfortable.

When the control switch 132 is disposed too low, the user needs to bend to operate. Continuously bending to hold and press the control switch 132 also causes the user to likely suffer from fatigue, and the operation is very uncomfortable. Therefore, in this disclosure, the selection of the value of the height between the control switch 132 and the ground comprehensively takes the human engineering concept into account. The control switch 132 is disposed at a suitable height so that the user does not need to raise the arm to perform a holding operation, and does not need to bend to perform the holding operation, thereby increasing the operational comfort when the user holds and presses the control switch 132, making the operation to be very convenient.

In addition, the control rod 130 is disposed upward on the leaf cleaning device 200, and the control switch 132 is disposed on the control rod 130, thereby improving the operational safety performance of the leaf cleaning device 200. In this disclosure, the reset mechanism is disposed inside the control switch 132. When the control switch 132 is under the force and is in the pressed state, the control switch 132 enables the electrical connection between the control switch 132 and the motor 40, and the motor 40 is started. When the pressure on the control switch 132 is canceled, the control switch 132 returns to the original state under the action of the reset mechanism, the electrical connection between the control switch 132 and the motor 40 is disabled, and the motor stops operating.

If required to keep the leaf cleaning device 200 continuously in an operating state, the user needs to continuously hold and press the control switch 132 with one hand, while the other hand of the user needs to operate an auxiliary tool such as a rake to move leaves around the leaf cleaning device 200 to a position near the air inlet 30 of the leaf cleaning device 20, so that the leaves are sucked into the inside of the machine by the leaf cleaning device 200 and are pulverized.

Because one hand of the user needs to continuously press the control switch 132 on the control rod 130, and the other hand needs to operate the rake to move the leaves around the leaf cleaning device 200 when the leaf cleaning device 200 is in the operating state, the two hands of the user are not free, and both have regular operations to perform. The user does not have extra time to extend a hand into the air inlet 30 of the leaf cleaning device 200. When the leaf cleaning device 200 is operating, extending the hand into the air inlet 30 may accidentally touch the blade of the leaf pulverizing apparatus in the leaf cleaning device 200, hurting the hand of the user.

For sake of safety, when the leaf cleaning device 200 is operating, a probability of damage resulting from touching the leaf pulverizing apparatus with two hands should be avoided if at all possible. In the present invention, when the leaf cleaning device 200 is operating, the two hands of the user are not free, and both have regular operations to perform, and do not have extra time to touch the blade of leaf pulverizing apparatus and get hurt. Therefore, the disposing of the control rod 130 and the control switch 132 may well satisfy the requirements of safety regulations, improve the safety performance of the leaf cleaning device 200, and better protect the user's safety.

In general, the control rod 130 is disposed upward on the leaf cleaning devices 200, and the control switch 132 is disposed on the control rod 130. On one hand, the comfort of the user operation may be improved, and on the other hand, the safety of the user operation may be improved.

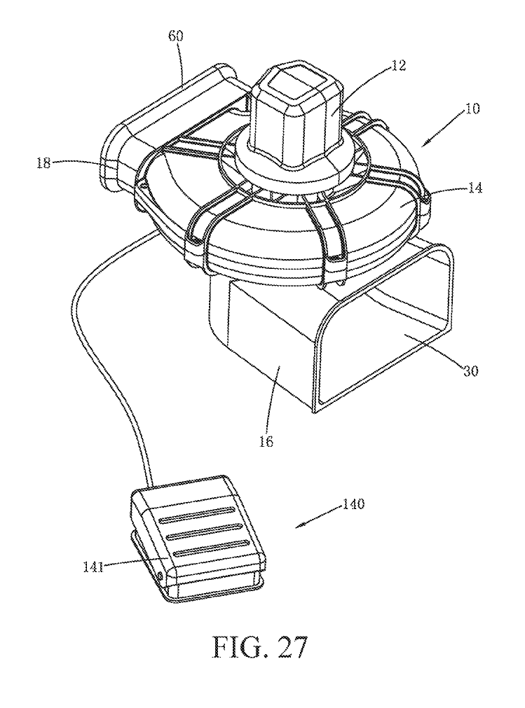

Referring to FIGS. 27 to 29, in in this disclosure, the leaf cleaning device 200 optionally includes a safeguard apparatus 140. The safeguard apparatus 140 includes a foot switch 141 electrically connected to the motor 40, the foot switch 141 being disposed outside the housing 10, and may be used for controlling operation and stop of the motor 40.

In the present invention, the foot switch 141 includes a reset mechanism. When the foot switch 141 is in a stepped state, the motor 40 starts operating; and when pressure applied to the foot switch 141 is canceled, the foot switch 141 returns to an original position under an action of the reset mechanism, in this case, an electrical connection between the foot switch 141 and the motor 40 is disabled, and the motor 40 stops operating.

Because in this disclosure the foot switch 141 includes the reset mechanism, if it is necessary to keep the leaf cleaning device 200 continuously in the operating state, the user needs to continuously step on the foot switch 141 by using one foot. The foot switch 141 is disposed at a distance from the housing 10, which enables one foot of the user to step on a pedal, while the other foot keeps a safe distance from the leaf cleaning device 200, so as to preclude the other foot of the user from touching the blade of the leaf pulverizing apparatus in the leaf cleaning device 200 and getting hurt.

Therefore, when the leaf cleaning device 200 is operating, one foot of the user continuously steps on the pedal, and the other foot keeps a sufficient safety distance from the blade of the leaf pulverizing apparatus in the leaf cleaning device 200, thereby improving the safety of the user operation, and keeping the feet of the user from touching the blade of the leaf pulverizing apparatus and getting hurt.

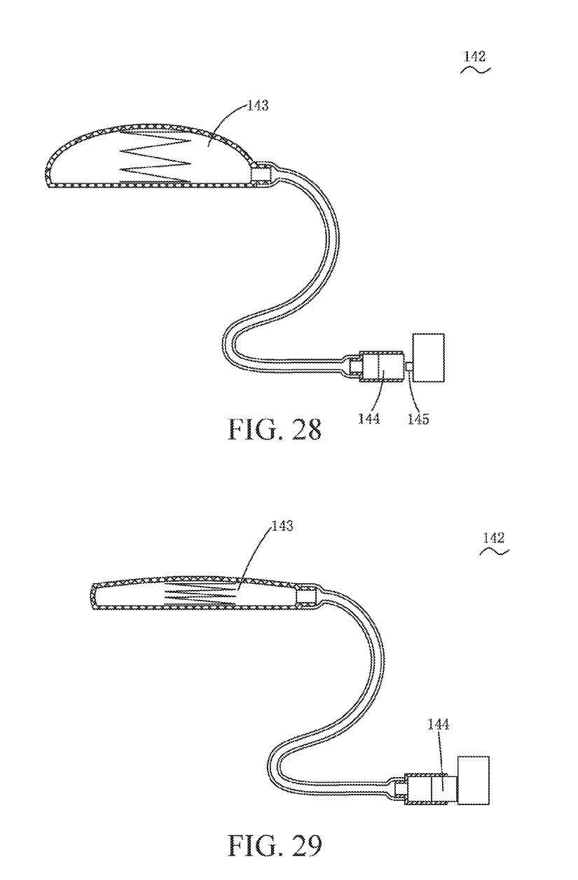

FIGS. 28 and 29 show another embodiment of a foot switch 142 controlling the on and off states of the motor 40 of the leaf cleaning device 200. The foot switch 142 uses an airbag 143 to coordinate with a piston 144, to trigger a trigger member 145 of the motor 40. When the user steps on the airbag 143, air in the airbag 143 pushes the piston 144 to move forward, and the piston 144 moves forward to press the trigger member 145. In this case, the motor 40 of the leaf cleaning device 200 is started. When the foot of the user stops stepping on the airbag 143, the airbag 143 is charged with air and returns to an original shape, and the piston 144 is sucked in, moving backward, to stop pressing the trigger member 145. In this case, the motor 40 of the leaf cleaning device 200 stops operating.

Similarly, the foot switch 142 needs one foot of the user to continuously step on the pedal to ensure continuous operation of the leaf cleaning device 200. Similarly, the foot switch 142 is disposed at a distance from the housing 10 to enable one foot of the user to step on the pedal, while the other foot keeps a safe distance from the leaf cleaning device 200 so as to avoid injury to the other foot by touching the blade of the leaf pulverizing apparatus in the leaf cleaning device 200.

Therefore, when the leaf cleaning device 200 is operating, one foot of the user continuously steps on the pedal while the other foot keeps a sufficient safe distance from the blade of the leaf pulverizing apparatus in the leaf cleaning device 200, thereby improving the safety of the user operation, and avoiding injury to the user's feet by touching the blade of the leaf pulverizing apparatus.

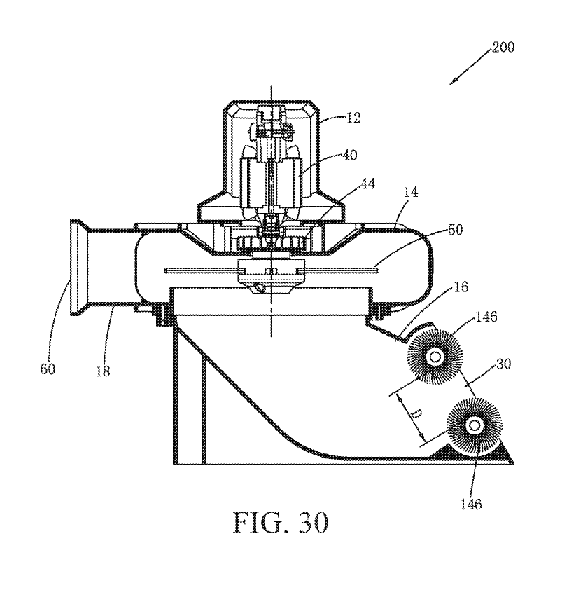

In an embodiment shown in FIG. 30, the safeguard apparatus 140 includes a roller 146 disposed at the air inlet 30 of the leaf cleaning device 200. The number of the roller 146 is set to two. One roller 146 is disposed at an upper end of the air inlet 30 and rotates clockwise about a rotation shaft; and the other roller 146 is disposed at a lower end of the air inlet 30 and rotates counterclockwise about another rotation shaft. The rotation shafts of the two rollers are parallel to each other and are both parallel to the ground.

In the figure given in this embodiment, the two rollers 146 are arranged close to the air inlet 30 and away from the air outlet 60 in a staggered manner. A person skilled in the art may imagine that in another embodiment, the two rollers 146 may be arranged along a vertical direction or arranged in another manner.

A gap exists between the two rollers 146 for leaves to enter the air inlet 30. The roller 146 at the upper end of air inlet 30 rotates clockwise about a rotation shaft, and the roller 146 disposed at the lower end of the air inlet 30 rotates counterclockwise about another rotation shaft. The upper and lower rollers 146 both rotate toward the inside of the air inlet 30 of the leaf cleaning device. Such a design may enable that once getting in contact with the air inlet 30, the leaves are lead by the rollers 146 to enter the inside of the leaf cleaning device 200, thereby improving the leaf intake efficiency of the air inlet 30 of the leaf cleaning device 200.

A range of a separation distance D between two hubs of the two rollers 146 is less than 7.5 cm. Such a distance setting may ensure that the user cannot extend a hand into the air inlet 30 of the leaf cleaning device 200 to touch the blade of the leaf pulverizing apparatus in the leaf cleaning device 200. When the leaf cleaning device 200 is operating, if the user extends the hand to touch the blade of the leaf pulverizing apparatus, the hand of the user gets hurt. Therefore, a limitation to the distance between the two rollers 146 may effectively improve the safety when the user operates the leaf cleaning device 200.

In this embodiment, the housing 10 of the leaf cleaning device 200 is further internally provided with a motor (not shown) for driving the two rollers 146. In another embodiment, the roller 146 is provided with a blade (not shown). When the leaf cleaning device 200 is operating, the leaf pulverizing apparatus rotates to generate air flow, and the air flow enters the inside of the leaf cleaning device 200 through the air inlet 30, and is discharged through the air outlet 60 of the leaf cleaning device 200. When the air flow enters the inside of the leaf cleaning device 200 through the air inlet 30, the air flow drives the blade and the roller 146 to rotate about the rotation shaft, and the rotation of the blade and the roller 146 about the rotation shaft may rapidly suck in leaves entering the air inlet 30 of the leaf cleaning device 200, thereby improving the efficiency of leaves entering the air inlet 30 of the leaf cleaning device 200.

The foregoing only describes the specific positions, number, and driving method of disposing the rollers 146 at the air inlet 30 with an example to make the inventive concept of this disclosure more easily understood, but is not a specific limitation to the specific positions, number, and driving method of the rollers 146. A person skilled in the art may imagine that besides some specific forms of the rollers 146 listed above, there may be other alternative forms. Any form that is basically the same as the inventive concept of this disclosure, and achieves basically the same effect pertaining to the inventive idea of this disclosure falls within the protection scope of this disclosure.

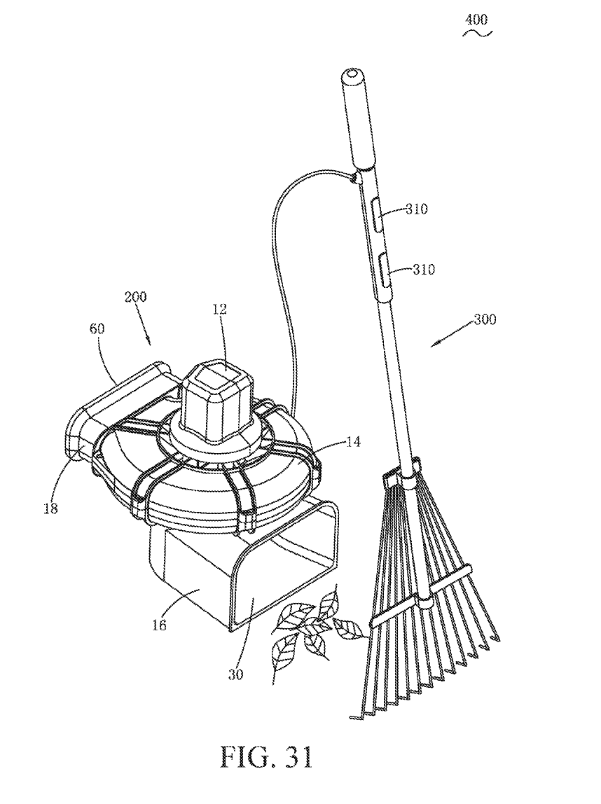

FIG. 31 shows a leaf removal system 400. The leaf removal system 400 includes a leaf cleaning device 200 and a rake 300. The leaf cleaning device 200 is used in coordination with the rake 300 to remove leaves on a lawn. The rake 300 is used for pushing the leaves on the ground to an air inlet 30 of the leaf cleaning device 200. A pair of control switches 310 may be detachably disposed on the rake 300, and the control switches 310 are used for controlling the on and off states of a motor 40 of the leaf cleaning device 200.

In this disclosure, the pair of control switches 310 on the rake 300 is set in such a manner that only when the pair of control switches 310 are pressed, an electrical connection between the leaf cleaning device 200 and the motor 40 is set up, so as to start the motor 40. When a user only presses one of the control switches 310, the motor 40 is still in a disabled state, and the motor 40 does not operate.

In the disclosure, the pair of control switches 310 on the rake 300 are also set to include reset mechanisms. When the pair of control switches 310 are simultaneously and continuously pressed, the electrical connection of the motor 40 is enabled, and the motor 40 starts rotating. When pressure on any one of the control switches 310 or on the two control switches 310 is canceled, the control switches 310 return to their original positions under actions of the reset mechanisms. In this case, the electrical connection of the motor 40 is disabled, and the motor 40 stops rotating.

In this disclosure, a pair of control switches 310 are disposed on the rake 300, and the control switches 310 are set to include the reset mechanisms. When it is necessary to keep the leaf cleaning device 200 in a continuously operating state, the user needs to simultaneously and continuously press the control switches 310 to ensure continuous operation of the leaf cleaning device 200. Therefore, when the leaf cleaning device 200 is operating to perform a leaf removal operation, the user needs to work with two hands, respectively pressing one control switch 310, and does not have an opportunity and time to extend a hand into the air inlet 30 of the leaf cleaning device 200 to accidentally touch a blade of a leaf pulverizing apparatus.

When the leaf cleaning device 200 is operating, the hand of the user may be seriously injured if it touches the blade of the leaf pulverizing apparatus. Therefore, in the disclosure, the design of the pair of control switches 310 on the rake 300 may effectively improve the safety when the user operates the leaf cleaning device 200 to perform the leaf removal operation.

In this disclosure, the pair of control switches 310 on the rake 300 may set up the electrical connection to the motor 40 of the leaf cleaning device 200 in a wired or wireless manner. Setting up the electrical connection in the wired manner pertains to the well-known general knowledge known by a person skilled in the art, and is not described in detail herein.

The following is to describe the main working principle of setting up the electrical connection in the wireless manner between the control switches 310 on the rake 300 and the motor 40 of the leaf cleaning device 200. The rake 300 is provided with a radio transmission module, and the leaf cleaning device 200 is provided with a corresponding radio receiving module and a control module. When the control switches 310 on the rake 300 are simultaneously pressed, the radio transmission module transmits an instruction of starting the motor 40 to the radio receiving module, the radio receiving module transmits the received instruction to the control module, and the control module starts the motor 40.

Similarly, when the user stops putting pressure on any control switch 310 of the pair of control switches 310 or simultaneously stops putting pressure on the pair of control switches 310, the radio transmission module transmits an instruction of turning off the motor 40 to the radio receiving module, the radio receiving module transmits the received instruction to the control module, and the control module turns off the motor 40.

Certainly, a person skilled in the art may imagine that the method for starting or stopping the motor 40 of the leaf cleaning device 200 by using the rake 300 in the wireless manner includes, but is not limited to, the foregoing method, and another method that can implement wireless control falls within the protection scope of thedisclosure.

Technical features of the embodiments described above may be arbitrarily combined with each other. For brevity of description, not all possible combinations of the technical features of the embodiments are described. However, as long as there is no contradiction between the combinations of these technical features, all the combinations should be considered as falling within the scope recorded by this specification.

The embodiments described above merely show some implementations of the present disclosure, which are described specifically and in detail, but should not be understood as a limitation to the patent scope of the present disclosure. It should be noted that, a person of ordinary skill in the art may further make some variations and improvements without departing from the concept of the present disclosure, and the variations and improvements fall within the protection scope of the present invention.

1. A leaf cleaning device, comprising:
a housing;
an air inlet configured to suck leaves into the housing;
an air outlet configured to discharge the leaves from the housing, and the air outlet connected to a leaf collection apparatus;
a motor located inside the housing; and
a leaf pulverizing apparatus driven by the motor and configured to rotate about an axis to pulverize the leaves, wherein
an area of the air inlet is greater than 260 square centimeters.

2. The leaf cleaning device according to claim 1, wherein the air inlet is in a shape of a rectangular opening.

3. The leaf cleaning device according to claim 2, wherein the air inlet comprises a length-to-width ratio in a range of greater than 0.5 and less than 2.

4. The leaf cleaning device according to claim 1, wherein the housing comprises a spiral housing and a first extending portion connected to the spiral housing, the first extending portion comprising a first end connected to a center of the spiral housing and a second end connected to the air inlet, and a cross-sectional area of the first end of the first extending portion is smaller than a cross-sectional area of the second end.

5. The leaf cleaning device according to claim 4, wherein a cross-sectional area of the first end is greater than 95 square centimeters.

6. The leaf cleaning device according to claim 5, wherein the first extending portion comprises a gradually increasing cross-sectional area from the first end to the second end.

7. The leaf cleaning device according to claim 4, wherein the leaf pulverizing apparatus is located at the center of the spiral housing, and the motor and the first extending portion are located on two opposite sides of the leaf pulverizing apparatus.

8. The leaf cleaning device according to claim 1, wherein a distance between the leaf pulverizing apparatus and the air inlet is less than 30 cm.

9. The leaf cleaning device according to claim 1, wherein the leaf pulverizing apparatus comprises a rotating disc and a flexible member disposed on the rotating disc, and a center of the rotating disc is fitted to an output shaft of the motor.

10. The leaf cleaning device according to claim 9, wherein the flexible member is a nylon rope.

11. The leaf cleaning device according to claim 1, wherein the leaf cleaning device comprises a support portion configured to be supported on the ground, and when the support portion is supported by the ground, the air inlet is close to the ground, and an angle of less than 60 degrees exists between the ground and a direction towards which the air inlet faces.

12. The leaf cleaning device according to claim 11, wherein the direction towards which the air inlet faces is parallel to the ground.

13. The leaf cleaning device according to claim 11, wherein a direction towards which the air outlet faces is parallel to the ground.

14. The leaf cleaning device according to claim 11, wherein the housing comprises a spiral housing, a first extending portion connected to a center of the spiral housing, and a second extending portion connected to an end of the spiral housing, wherein the first extending portion is connected to the air inlet, and the second extending portion is connected to the air outlet.

15. The leaf cleaning device according to claim 14, wherein the support portion is disposed on the first extending portion.

16. The leaf cleaning device according to claim 14, wherein the first extending portion comprises a first end connected to the center of the spiral housing and a second end connected to the air inlet, and a cross-sectional area of the first end of the first extending portion is smaller than a cross-sectional area of the second end.

17. The leaf cleaning device according to claim 11, wherein the leaf pulverizing apparatus comprises a rotating disc and a flexible member disposed on the rotating disc, and a center of the rotating disc is fitted to an output shaft of the motor.

18. The leaf cleaning device according to claim 17, wherein the flexible member is a nylon rope.

19. The leaf cleaning device according to claim 1, wherein the leaf cleaning device comprises a support portion configured to be supported on the ground, the air inlet comprises a normal line running through the air inlet, and when the support portion is supported by the ground, an angle of less than 60 degrees exists between the normal line and the ground.

20. The leaf cleaning device according to claim 1, wherein the leaf cleaning device comprises a support portion configured to be supported on the ground, the support portion defines a support plane, the air inlet defines an air intake plane configured to allow leaves to pass through, and an angle between the support plane and the air intake plane is greater than 30 degrees.
